(19) United States
(12) Patent Application Publication
(10) Pub. No.: US 2005/0050129 A1
(43) Pub. Date: Mar. 3, 2005

(54) Method of estimating a penetrance and evaluating a relationship between diplotype configuration and phenotype using genotype data and phenotype data

(75) Inventors: Naoyuki Kamatani, Tokyo (JP); Toshikazu Ito, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Mitsubishi Research Institute, Inc., Tokyo (JP); Tailoraid, Ichikawa-shi (JP)

(21) Appl. No.: 10/840,645

(22) Filed: May 7, 2004

(30) Foreign Application Priority Data
May 8, 2003 (JP) 130638/2003
Apr. 26, 2004 (JP) 130349/2004

(51) Int. Cl. G06F 17/15

(52) U.S. Cl. 708/422

(57) ABSTRACT

A method of simultaneously estimating a diplotype-based penetrance as well as haplotype frequencies and diplotype configurations on the basis of observed genotype and phenotype data. The method includes a step a of calculating, on the basis of genotype data and phenotype data with haplotype frequencies and penetrance used as parameters, the maximum likelihood (L₀ₘₐₓ) obtained by maximizing likelihood under the hypothesis that there is no association between predetermined diplotype configurations and a predetermined phenotype, the maximum likelihood estimates of haplotype frequencies and penetrances, the maximum likelihood (Lₘₐₓ) obtained by maximizing likelihood under the hypothesis that there is an association between the predetermined diplotype configurations and the predetermined phenotype; and a step b of calculating the penetrance from the maximum likelihood estimate obtained in said step a.

### BACKGROUND OF THE INVENTION

1. Field of the Invention

The present invention relates to a method of estimating a penetrance by using genotype data and phenotype data observed in a predetermined population. The present invention also relates to a method of estimating the probability of a new particular individual developing a phenotype by using genotype data on the individual and by using a penetrance (estimated value) obtained by using the penetrance estimation method.

2. Background Art

Analysis of polymorphism based on linkage disequilibrium (LD) and haplotype structure is becoming increasingly important. A combination of a plurality of linked alleles existing in one gamete is defined here as a haplotype. Also, non-independence of different alleles is defined as linkage disequilibrium. An allele represents a polymorphism in a one of a pair of chromosomes in terms of molecular biology.

Recent studies analyzing data on multiple linked loci (alleles) in many individuals have clarified the structure of the human genome from the viewpoint of the population genetics. That is, it has been made clear that the human genome has a haplotype block (or LD block) structure. Within a block, LD is strong and the number of major haplotypes is limited. One can extract tag SNPs (single nucleotide polymorphism, single base substituted) from the SNPs within the block and use them for association studies. That is, the haplotype structure is very useful for fine mapping of traits.

Haplotypes are also useful for association of genetic information about humans with various phenotypes. A phenotype is often associated not only with each SNP but also with haplotypes. We can interpret haplotypes as complete data and genotypes (e.g., SNP genotypes) as incomplete data. It is because we can extract all genotype data from haplotype data, while the reverse is not the case.

In fact, we can redefine an allele at a locus as a set of multiple haplotypes that have the allele at the locus. Therefore, it is more general to consider the association between a polymorphism and a phenotype based on a haplotype or a diplotype configuration (a combination of haplotypes) rather than based on allele or genotypes. Many studies recently made have suggested that phenotypes such as diabetes and reaction to drugs are associated with haplotypes or diplotype configurations rather than genotypes such as SNP.

However, a haplotype or a diplotype configuration of a subject cannot easily be observed although instances of experimental direct determination of haplotypes have been reported. Haplotypes are inferred by various algorithms using multilocus genotype data instead of being directly observed. That is, Clark's algorithm (see non-patent document 1), the expectation-maximization (EM) algorithm (see non-patent documents 2 to 6), the PHASE algorithm, the PL-EM algorithm, and so on have been proposed.

In genome-based association analysis based on haplotypes, haplotype frequencies are estimated by one of the above-mentioned algorithms. The haplotype frequencies are then compared based on the estimated values among case and control groups. Zaykin et al. have published an algorithm for analysis of the association between haplotype frequencies and traits based on an regression-based approach even in the presence of diplotype configurations not concentrated with respect to discrete or continuous traits (see non-patent document 7). Fallin et al. have also proposed a method of testing the associations between estimated haplotype frequencies and traits on the basis of case/control sampling design (see non-patent document 8).

However, when phenotypes at the level of individuals are brought into focus, they ought be based on diplotype configurations rather than the haplotypes. This relationship is equivalent to that between genotypes and alleles at a locus. In examining the association between a phenotype and genetic information in some cases, therefore, comparing the proportions of affected subjects among individuals with different diplotype configurations is more effective than comparing the haplotype frequencies among different phenotypes.

To compare the proportions of affected subjects among individuals with different diplotype configurations, the diplotype configuration of each individual is inferred by using one of the above-mentioned algorithms and all the individuals are classified according to the presence or absence of a haplotype or a diplotype configuration. The affected and non-affected subjects in populations classified in this manner are further classified and a test as to the independence is thereafter carried out.

However, the problem is that, at least in some individuals, diplotype configurations are not unequivocally determined (only ambiguous diplotype configurations are obtained). The degree of type I error due to classification of individuals according to inferred haplotype information used instead of real haplotype information cannot be distinctly ascertained.

[Non-Patent Document 1]

Clark A G, Weiss K M, Nickerson D A et al (1998) Haplotype structure and population genetic inferences from nucleotide-sequence variation in human lipoprotein lipase, Am. J. Hum. Genet. 63: 595-612
   [Non-Patent Document 2]
Excoffier L, Slatkin M (1995) Maximum-likelihood estimation of molecular haplotype frequencies in a diploid population, Mol. Biol. Evol. 12: 921-927
   [Non-Patent Document 3]
Hawley M E, Kidd K K (1995) HAPLO: a program using the EM algorithm to estimate the frequencies of multi-site haplotypes, J. Hered. 86: 409-411
   [Non-Patent Document 4]
Schneider S, Roessli D, Excoffier L (2000) Arlequin: a software for population genetics data analysis, Ver 2.000, Genetics and Biometry Laboratory, Department of Anthropology, University of Geneva, Geneva
   [Non-Patent Document 5]
Long J C, Williams R C, Urbanek M (1995) An E-M algorithm and testing strategy for multiple locus haplotypes, Am. J. Hum. Genet. 56: 799-810
   [Non-Patent Document 6]
Kitamura Y, Moriguchi M, Kaneko H, Morisaki H, Morisaki T, Toyama K, Kamatani N (2002), Determination of probability distribution of diplotype configuration (diplotype distribution) for each subject from genotypic data using the EM algorithm, Ann. Hum. Genet. 66: 183-193
   [Non-Patent Document 7]
Zaykin D V, Westfall P H, Young S S, Karnoub M A, Wagner M J, Ehm M G (2002), Testing association of statistically inferred haplotypes with discrete and continuous traits in samples of unrelated individuals, Hum. Hered. 53: 79-91
   [Non-Patent Document 8]
Fallin D, Schork N.J. (2000), Accuracy of haplotype frequency estimation for biallelic loci, via the expectation-maximization algorithm for unphased diploid genotype data, Am. J. Hum. Genet. 67: 947-959

### SUMMARY OF THE INVENTION

In view of the above-described problem, an object of the present invention is to provide an algorithm for estimating a diplotype-based penetrance as well as haplotype frequencies and diplotype configurations on the basis of observed genotype and phenotype data. Another object of the present invention is to provide an algorithm for estimating the probability of development of a predetermined phenotype in a tested individual on the basis of genotype data on the individual.

An algorithm in accordance with the present invention enables maximum likelihood estimation of haplotype frequencies in a population, diplotype distributions of individuals (posterior probability distributions of diplotype configurations) and penetrances when genotype data and phenotype data are given, while eliminating the need for definitely determining diplotype configurations of the individuals. If the algorithm in accordance with the present invention is used, for example, the association between the existence of a haplotype and one phenotype can be tested by using genotype data and phenotype data obtained as a result of a cohort study or a clinical trial. The inventors of the present invention studied the effectiveness of the algorithm by using both simulation and real data, found that the algorithm is advantageously effective in analysis of genotype data and phenotype data in cohort studies and clinical trials, and completed the present invention. Further, the inventors of the present invention found that the algorithm can also be applied to analysis of genotype data and phenotype data obtained as a result of a case-control study.

That is, the present invention comprises methods and so on described below.

(1) A penetrance estimation method comprising:
a step a of calculating, on the basis of genotype data and phenotype data with haplotype frequencies and penetrance used as parameters, the maximum likelihood (L₀ₘₐₓ) obtained by maximizing likelihood under the hypothesis that there is no association between predetermined diplotype configurations and a predetermined phenotype, the maximum likelihood estimates of haplotype frequencies and penetrances, and the maximum likelihood (Lₘₐₓ) obtained by maximizing likelihood under the hypothesis that there is an association between the predetermined diplotype configurations and the predetermined phenotype; and
a step b of obtaining the penetrance from the maximum likelihood estimates obtained in the step a.

(2) The penetrance estimation method described in (1), wherein genotype data and phenotype data obtained as a result of a cohort study or a clinical trial and observed in a predetermined population are used, wherein the step a, the maximum likelihood (Lₘₐₓ) is obtained by maximizing the following expression (I) over Θ, q₊ and q₋:

$$L ( Θ , {q}_{+} , {q}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{+} , {q}_{-} ) \qquad ( I )$$

and the maximum likelihood (L₀ₘₐₓ) is obtained by maximizing the following expression (II) over Θ and q₀:

$$L ( Θ , {q}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{0} ) \qquad ( II )$$

(in expressions (I) and (II), Θ denotes a vector of the haplotype frequencies; q₊ denotes the probability that a phenotype ψ₊ results under
diεD₊
   where D₊ denotes a set of diplotype configurations containing elements of a set of haplotypes relating to the predetermined phenotype, and dᵢ denotes a diplotype configuration of the ith individual in N individuals; q₋ denotes the probability that a phenotype ψ₊ results under
di∉D₊
   ; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual.)

(3) The penetrance estimation method described in (1), wherein genotype data and phenotype data obtained as a result of a case-control study are used wherein the step a, the maximum likelihood (Lₘₐₓ) is obtained by maximizing the following expression (I) over Θ, r₊ and r₋:

$$L ( Θ , {r}_{+} , {r}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{+} , {r}_{-} ) \qquad ( I )$$

the maximum likelihood (L₀ₘₐₓ) is obtained by maximizing the following expression (II) over Θ and r₀:

$$L ( Θ , {r}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{0} ) \qquad ( II )$$

(in expressions (I) and (II), Θ denotes a vector of the haplotype frequencies; r₊ denotes an estimate under
diεD₊
   where D₊ denotes a set of diplotype configurations containing elements of a set of haplotypes relating to the predetermined phenotype, and dᵢ denotes a diplotype configuration of the ith individual in N individuals; r₋ denotes an estimate under
di∉D₊
   ; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual.)
and, wherein the penetrance is obtained as q₊ by substituting r₊ obtained by expression (I) in the following equation:

$${q}_{+} = \frac{1}{\frac{ω}{( 1 - ω )} \frac{( 1 - {r}_{+} )}{{r}_{+}} \frac{( 1 - λ )}{λ} + 1}$$

where λ denotes the proportion of cases in the entire population, and ω denotes the proportion of a case population in a population consisting of the case population and a control population extracted from the entire population.

(4) In the penetrance estimation method described in (1), wherein a set of haplotypes to be tested is defined in such a limiting manner that loci for giving information for discrimination between individual haplotypes and loci having redundant information due to combinations of the loci for giving the discrimination information are determined on the basis of the haplotype frequencies used as a parameter, and the determined loci are masked.

(5) A method of testing a relationship between a diplotype configuration and a phenotype, comprisng:
a step a of calculating, on the basis of genotype data and phenotype data with haplotype frequencies and penetrance used as parameters, the maximum likelihood (L₀ₘₐₓ) obtained by maximizing likelihood under the hypothesis that there is no association between predetermined diplotype configurations and a predetermined phenotype, the maximum likelihood estimate of haplotype frequencies and penetrances, and the maximum likelihood (Lₘₐₓ) obtained by maximizing likelihood under the hypothesis that there is an association between the predetermined diplotype configurations and the predetermined phenotype; and
a step b of obtaining a likelihood ratio from the maximum likelihood (L₀ₘₐₓ) and the maximum likelihood (Lₘₐₓ) obtained in the step a, and testing, with reference to an λ² distribution, the hypothesis that there is an association between the predetermined deplotype and the predetermined phenotype.

(6) The method of testing a relationship between a diplotype configuration and a phenotype described in (5), wherein genotype data and phenotype data obtained as a result of a cohort study or a clinical trial and observed in a predetermined population are used wherein the step a, the maximum likelihood (Lₘₐₓ) is obtained by maximizing the following expression (I) over Θ, q₊ and q₋:

$$L ( Θ , {q}_{+} , {q}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{+} , {q}_{-} ) \qquad ( I )$$

and the maximum likelihood (L₀ₘₐₓ) is obtained by maximizing the following expression (II) over Θ and q₀:

$$L ( Θ , {q}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{0} ) \qquad ( II )$$

(in expressions (I) and (II), Θ denotes a vector of the haplotype frequencies; q₊ denotes the probability that a phenotype ψ₊ results under
diεD₊
   where D₊ denotes a set of diplotype configurations containing elements of a set of haplotypes relating to the predetermined phenotype, and dᵢ denotes a diplotype configuration of the ith individual in N individuals; q₋ denotes the probability that a phenotype ψ₊ results under
di∉D₊
   ; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual.)

(7) The method of estimating the probability of development of a phenotype, described in (9), wherein, in said step b, −2log(Lₘₐₓ/L₀ₘₐₓ) is obtained as a statistic (where log denotes natural logarithm), and wherein because the static asymptotically follows the λ² distribution with the degree of freedom of 1 in a case where the diplotype configuration and the phenotype are independent of each other, it is determined that it cannot be said that there is an association between the predetermined diplotype configurations and the predetermined phenotype, when the statistic does not exceed a limit value λ²< (which is a value at which a cumulative distribution function is 1-α in λ² distribution with the degree of freedom of 1, where α denotes the risk rate of the test), and it is determined that there is an association between the predetermined diplotype configurations and the predetermined phenotype, when the statistic exceeds the limit value λ²<.

(8) The method of testing a relationship between a diplotype configuration and a phenotype, described in (5), wherein genotype data and phenotype data obtained as a result of a case-control study are used. In the above-described step a, the maximum likelihood (Lₘₐₓ) is obtained by maximizing the following expression (I) over Θ, r₊ and r₋:

$$L ( Θ , {r}_{+} , {r}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{+} , {r}_{-} ) \qquad ( I )$$

and the maximum likelihood (L₀ₘₐₓ) is obtained by maximizing the following expression (II) over Θ and r₀:

$$L ( Θ , {r}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{0} ) \qquad ( II )$$

(in expressions (I) and (II), Θ denotes a vector of the haplotype frequencies; r₊ denotes an estimate under
diεD₊
   where D₊ denotes a set of diplotype configurations containing elements of a set of haplotypes relating to the predetermined phenotype, and dᵢ denotes a diplotype configuration of the ith individual in N individuals; r₋ denotes an estimate under
di∉D₊
   ; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual.)
and, wherein penetrance is obtained as q₊ by substituting r₊ obtained by expression (I) in the following equation:

$${q}_{+} = \frac{1}{\frac{ω}{( 1 - ω )} \frac{( 1 - {r}_{+} )}{{r}_{+}} \frac{( 1 - λ )}{λ} + 1}$$

where λ denotes the proportion of cases in the entire population, and ω denotes the proportion of a case population in a population consisting of the case population and a control population extracted from the entire population.

(9) The method of testing a relationship between a diplotype configuration and a phenotype, described in (5), wherein a set of haplotypes to be tested is defined in such a limiting manner that loci for giving information for discrimination between individual haplotypes and loci having redundant information due to combinations of the loci having the discrimination information are determined on the basis of the haplotype frequencies used as a parameter, and the determined loci are masked.

(10) A method of estimating the probability of development of a phenotype, comprising:
a step a of calculating, on the basis of genotype data and phenotype data with haplotype frequencies and penetrance used as parameters, a maximum likelihood (L₀ₘₐₓ) obtained by maximizing likelihood under the hypothesis that there is no association between predetermined diplotype configurations and a predetermined phenotype, the maximum likelihood estimates of and haplotype frequencies and penetrances, and the maximum likelihood (Lₘₐₓ) obtained by maximizing likelihood under the hypothesis that there is an association between the predetermined diplotype configurations and the predetermined phenotype; and
a step b of obtaining the probability that tested individual develops the predetermined phenotype, by using the maximum likelihood estimates obtained in the step a and the genotype data on the tested individual.

(11) The method of estimating the probability of development of a phenotype, described in (10), wherein genotype data and phenotype data obtained as a result of a cohort study or a clinical trial and observed in a predetermined population are used. In the above-described step a, the maximum likelihood (Lₘₐₓ) is obtained by maximizing the following expression (I) over Θ, q₊ and q₋:

$$L ( Θ , {q}_{+} , {q}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{+} , {q}_{-} ) \qquad ( I )$$

and the maximum likelihood (L₀ₘₐₓ) is obtained by maximizing the following expression (II) over Θ and q₀:

$$L ( Θ , {q}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{0} ) \qquad ( II )$$

(in expressions (I) and (II), Θ denotes a vector of the haplotype frequencies; q₊ denotes the probability that a phenotype ψ₊ results under
diεD₊
   where D₊ denotes a set of diplotype configurations containing elements of a set of haplotypes relating to the predetermined phenotype, and dᵢ denotes a diplotype configuration of the ith individual in N individuals; q₋ denotes the probability that a phenotype ψ₊ results under
di∉D₊
   ; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual.)

(12) The method of estimating the probability of development of a phenotype, described in (10), wherein genotype data and phenotype data obtained as a result of a case-control study are used, wherein the step a, the maximum likelihood (Lₘₐₓ) is obtained by maximizing the following expression (I) over Θ, r₊ and r₋:

$$L ( Θ , {r}_{+} , {r}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{+} , {r}_{-} ) \qquad ( I )$$

and the maximum likelihood (L₀ₘₐₓ) is obtained by maximizing the following expression (II) over Θ and r₀:

$$L ( Θ , {r}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{0} ) \qquad ( II )$$

(in expressions (I) and (II), Θ denotes a vector of the haplotype frequencies; r₊ denotes an estimate under
diεD₊
   where D₊ denotes a set of diplotype configurations containing elements of a set of haplotypes relating to the predetermined phenotype, and dᵢ denotes a diplotype configuration of the ith individual in N individuals; r₋ denotes an estimate under
di∉D₊
   ; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual.)
and, wherein the penetrance is obtained as q₊ by substituting r₊ obtained by expression (I) in the following equation:

$${q}_{+} = \frac{1}{\frac{ω}{( 1 - ω )} \frac{( 1 - {r}_{+} )}{{r}_{+}} \frac{( 1 - λ )}{λ} + 1}$$

where λ denotes the proportion of cases in the entire population, and co denotes the proportion of a case population in a population consisting of the case population and a control population extracted from the entire population.

(13) The method of estimating the probability of development of a phenotype, described in (10), wherein a set of haplotypes to be tested is defined in such a limiting manner that loci for giving information for discrimination between individual haplotypes and loci having redundant information due to combinations of the loci having the discrimination information are determined on the basis of the haplotype frequencies used as a parameter, and the determined loci are masked.

(14) The method of estimating the probability of development of a phenotype, described in (10), wherein, in said step b, the probability is obtained by the following equation (III):

$$P ( {ψ}_{N + 1} = {ψ}_{+} \vert {g}_{N + 1} , \hat{Θ} ) = {\hat{q}}_{+} {\sum }_{{a}_{k} ∈ {D}_{+}} P ( {d}_{N + 1} = {a}_{k} \vert {g}_{N + 1} , \hat{Θ} ) + {\hat{q}}_{-} {\sum }_{{a}_{k} ∈ {D}_{+}} P ( {d}_{N + 1} = {a}_{k} \vert {g}_{N + 1} , \hat{Θ} ) \qquad ( III )$$

(In equation (III), the tested individual is shown as the N+1th individual, g_{N+1} denotes a genotype of the observed individual, and
\hat{Θ}
\hat{q}₊
\hat{q}₋
   respectively denote the values of Θ, q₊ and q₋ at which L(ΘD, q₊ and q₋) is maximized in said step a).

The present invention also comprises a program for enabling a computer to carry out any of the above-described methods (1) to (14). That is, each of the above-described methods (1) to (14) can be implemented as a program for enabling a computer having pieces of hardware such as a controller, a transmitter/receiver and a storage device to execute each step.

### BRIEF DESCRIPTION OF THE DRAWINGS

FIG. 1 is a characteristic diagram showing the relationship between q₊ and r₊ in a case where the number of cases and the number of controls are equal to each other and the value of λ is set to 0.1, 0.01 and 0.001.

FIG. 2 is a characteristic diagram in a case where λ is set 0.01 and the ratio of cases and controls (case/control) to 1, 5, and 10.

FIG. 3 is a histogram of a statistic −log(L₀ₘₐₓ/Lₘₐₓ) in the case of analysis of data generated under the null hypothesis.

FIG. 4 is a characteristic diagram showing the relationship between q₊/q₋ (relative risk) and the statistic −log(L₀ₘₐₓ/Lₘₐₓ) produced under the alternative hypothesis.

FIG. 5 is a characteristic diagram showing the increase in power with the increases in q₊/q₋ (relative risk) and sample size N.

FIG. 6 is a characteristic diagram showing the relationship between the frequency of “phenotype-associated haplotype” and the power.

FIG. 7 is a characteristic diagram showing the relationship between the number of cases or controls and type I error in a case where SAA gene haplotype frequency data is used.

FIG. 8 is a characteristic diagram showing the relationship between the number of cases or controls and type I error in a case where ART haplotype frequency data is used.

FIG. 9 is a characteristic diagram showing the results of simulation using the present algorithm to obtain type I error under the null hypothesis and using separate3 method to obtain type I error under the null hypothesis.

### DETAILED DESCRIPTION OF THE PREFERRED EMBODIMENTS

The present invention will be described below in detail.

The penetrance estimation method and the phenotype development probability estimation method in accordance with the present invention are implemented by means of an algorithm described below (hereinafter referred to as “the present algorithm”). In use of this algorithm, genotype data and phenotype data observed in a predetermined population obtained as a result of a cohort study or a clinical trial or genotype data and phenotype data observed in a predetermined population obtained as a result of a case control study can be used.

1. Application to Cohort Study or Clinical Trial

Description will be first made of a method in which the association between the existence of a phenotype and the existence of a haplotype is tested by using genotype data and phenotype data on individuals obtained by a cohort study or a clinical trial to estimated a penetrance on the basis of the haplotype. This algorithm is formed on the basis of an EM algorithm.

By this algorithm, the frequency of a haplotype in a population and penetrances differing between individuals having the haplotype and other individuals not having the haplotype can be estimated. Therefore, this algorithm also enables maximum-likelihood estimation of a relative risk. More specifically, the maximum likelihood (L₀ₘₐₓ) under a hypothesis that there is no association between a phenotype and a haplotype (the null hypothesis; there is one penetrance) and the maximum likelihood (Lₘₐₓ) under a hypothesis that there is an association (the alternative hypothesis; there are two penetrances) are first calculated. Next, in this algorithm, a statistic, e.g., −2log(L₀ₘₐₓ/Lₘₐₓ) (hereinafter referred to simply as “statistic”) is computed. The association between the phenotype and the haplotype is tested on the basis of this statistic.

This algorithm can be applied to a method of estimating the probability of development of a phenotype from genotype information on a specimen. That is, this algorithm enables estimation of the probability of development of a predetermined phenotype in a specimen on the basis of genotype information on the specimen. Therefore, this algorithm useful for analysis of the association between a genetic factor and reaction of an individual to a drug. This algorithm can be executed on a computer by being implemented in the computer program PENHAPLO. The computer has a central processing unit (CPU) (control means) for overall control on the operation, a keyboard and a mouse capable of inputting an instruction for executing a program and so on, an input means for obtaining various sorts of data stored on a storage medium (database) or the like, a display means such as a display device, a memory in which temporary information, a program and so on are recorded, and a storage means such as a hard disk on which various sorts of data, a program and so on are stored. The computer may be connected to an external database, another computer and the like via a communication network such as the Internet.

For execution of this algorithm on the computer, the computer program PENHAPLO is installed in the computer. The computer can execute this algorithm in accordance with the computer program PENHAPLO under the control of the CPU. Genotype data and phenotype data may be input, for example, via a communication network such as the Internet, or from a storage medium on which genotype data and/or phenotype data is stored.

That is, the present algorithm enables the computer to function as an input means for obtaining genotype data and phenotype data and as a control means (computation means) for obtaining the maximum-likelihood estimate and the maximum likelihood (Lₘₐₓ) of haplotype frequencies and penetrances by using the genotype and phenotype data obtained by the input means. The present algorithm also enables the computer to function so as to obtain the penetrance from the maximum-likelihood estimate by means of the control means. Further, the present algorithm enables the computer to function so as to obtain, by means of the control means, the likelihood ratio from the maximum likelihood (L₀ₘₐₓ) and the maximum likelihood (Lₘₐₓ) and to test, with reference to the λ² distribution, a hypothesis that a predetermined diplotype configurations and a predetermined phenotype are associated with each other. Further, the present algorithm enables the computer to function so as to obtain the probability that any of individuals to be tested develops the predetermined phenotype by means of the control means using the maximum likelihood estimate and the genotype data on the individuals.

The genotype data comprises information denoting the position of a polymorphism obtained as a result of execution of so-called SNP typing or the like on a certain individual and information denoting the kind of the polymorphism. The genotype data may be made anonymous by removing information identifying the individual.

The phenotype data comprises binary data denoting whether or not a certain individual has a predetermined phenotype. The particular phenotype may be, for example, the existence/nonexistence of a drug action or a side effect, or an affected/non-affected state checked by a clinical test and diagnosis or the like.

Algorithm

The present algorithm will be described in detail.

<Sample Space>

Let us assume that there are 1 linked SNP loci. The number of all the possible haplotypes is L=2¹. We set up a collection of infinite number of haplotype copies. The haplotype frequencies in the collection are Θ=(θ₁, . . . ,θⱼ, . . . , θ_{L}), where θⱼ is the frequency of jth haplotype, and
θj≧0,

$${\sum }_{j = 1}^{L} θ j = 1$$

To each of N individuals, ordered two haplotype copies are given by randomly extracting them from the collection of the haplotype copies. Let a₁, a₂, . . . , a_{L2} be possible diplotype configurations. The probability that ith subject has the diplotype configuration aₖ is P(dᵢ=aₖ|Θ)=θ₁θₘ, where dᵢ is a diplotype configuration for the ith subject, and 1, m are the orders of the haplotypes that constitute aₖ. This means that Hardy-Weinberg's equilibrium is assumed at the haplotype level. The ith subject develops the phenotype ψ₊ at the probability determined as a function of dᵢ. Theoretically the penetrances can be defined for all the diplotype configurations. However, it is not realistic to assign different penetrances to all the different diplotype configurations. We then defined only two penetrances. Let Hₐₗₗ denote the set of all the haplotypes, and let H₊ denote the subset of Hₐₗₗ containing the haplotype or haplotypes the presence of which has a different effect than the others. H₊ typically contains only one haplotype, but may contain multiple haplotypes. If H₊ is set up so that it contains all the haplotypes with an allele at a locus, then it is equivalent to the situation of testing the association of an allele (rather than a haplotype) with the phenotype.

The subset of Hₐₗₗ is not limited to H₊. H₁ described below may be defined. H₁ is defined as a subset of Hₐₗₗ in such a manner that loci for giving information for discrimination between individual haplotypes and loci having redundant information due to combinations of the loci having the discrimination information are determined on the basis of a haplotype distribution inferred by the EM algorithm, and the determined loci are masked.

This masking means concealing the information at particular one or more of the plurality of loci constituting the haplotypes by assuming that any polymorphism can apply to the particular locus or loci. Thus, the concept of an incomplete haplotype having its portion concealed by masking is expressed as a set H₁ including a plurality of haplotypes as constituents. From the definition of H₁,

H₁⊂Hₐₗₗ

is apparent. Further, if an incomplete haplotype is constructed by using information on only one locus and by masking the other loci, only SNP information on the used locus is used. This incomplete haplotype is therefore equivalent to SNP. If haplotypes formed in this manner are defined as a set H_{SNP}, H_{SNP} is a particular case of H₁, and

H₁⊂H_{SNP}⊂Hₐₗₗ

The rationality of using incomplete haplotypes H₁ in place of H₊ is as described below.

1) In a case where a gene polymorphism is expressed by haplotypes, the cause of the polymorphism comprises base substitution and recombination. In a case where a haplotype in a certain region is associated with a cause locus associated with a certain phenotype, a plurality of haplotypes may be associated with the cause locus. This association is due to a mutation or recombination caused after the occurrence of the cause locus. If incomplete haplotypes are constructed, a mutation can be expressed as masking at a particular locus and recombination can be expressed as masking at consecutive loci.

2) When incomplete haplotypes are constructed by using SNP information on L loci, the loci to be masked are changed from 0 to L−1 to enable haplotypes from those using all the information items to SNP to be included in objects to be tested by the present algorithm.

If all incomplete haplotypes H₁ are constructed by using SNP information on the L loci, three information items consisting of two alleles and masking operation is used with respect to each locus and, to put it simply, there is a need to consider 3^{L}−1 combinations. The number of combinations is excessively large even in comparison with the number of combinations in haplotype estimation is 2^{L}. However, the number of haplotypes is ordinarily smaller than 10 in a region where linkage disequilibrium is strong, and it is not necessary to simply construct all the possible combinations. Therefore, incomplete haplotypes H₁ may be constructed in accordance with an algorithm having the following steps 1 to 3.

1. Haplotype estimation based on the EM algorithm is performed.

2. From a haplotype distribution thereby estimated, loci for giving information for discrimination between individual haplotypes are extracted. From the loci thereby extracted, those having redundant information due to combinations are removed to determine haplotype tags SNP(hereinafter referred to as htSNP).

3. To the htSNP loci, three information items consisting of two alleles and a masking operation are successively applied to construct incomplete haplotypes H₁. There is a possibility of identical haplotypes H₁ being constructed even by different masking methods. A redundant haplotype constructed in such a case is also removed.

Description will be made with respect to a case where H₊is provided as an object to be tested. However, the same objects to be tested as the above-described incomplete haplotypes H₁ may alternatively be provided.

Let D₊ denote a set of diplotype configurations that contain a member or members of H₊. Let q+ denote the probability that the ith individual develops ψ₊ when
diεD₊
   and let q₋ denote the probability that the ith individual develops ψ₊ when
di∉D₊

That is, if ψᵢ denotes the phenotype of ith subject,
P(ψᵢ=ψ+|dᵢεD₊)=q₊
P(ψᵢ=ψ+|dᵢ∉D₊)=q₋
Note that Θ and q₊, q₋ are independent.

The present algorithm is different from the conventional EM algorithm in that the process of developing a phenotype is included in the present algorithm. In the present algorithm, the parameters such as q₊ and q₋ are also included in the probability apace in addition to Θ. Note that ψᵢ is independent of Θ conditionally on dᵢ, particularly in this algorithm.

<Likelihood Function>

The observed data used in the present algorithm are genotype data and phenotype data on individuals. Let G_{obs}=(g₁, g₂, . . . , g_{N}) and ψ_{obs}=(w₁, w₂, . . . , w_{N}) denote the vectors of the observed genotypes and phenotypes, respectively, where gᵢ and wᵢ denote the observed genotype and phenotype of the ith individual. Then the likelihood function is

$$L ( Θ , {q}_{+} , {q}_{-} ) ∝ {\prod }_{i = 1}^{N} {\sum }_{{a}_{k} ∈ {A}_{i}} P ( {d}_{i} = {a}_{k} \vert Θ , {q}_{+} , {q}_{-} ) P ( {ψ}_{i} = {w}_{i} \vert {d}_{i} = {a}_{k} , Θ , {q}_{+} , {q}_{-} )$$

where Aᵢ denotes the set of aₖ for the ith individual that is consistent with gᵢ.

Since dᵢ is independent of q₊, q₋ and ψᵢ is independent of Θ conditionally on dᵢ,

$$L ( Θ , {q}_{+} , {q}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{+} , {q}_{-} ) \qquad ( I )$$

where Aᵢ denotes the set of aₖ for the ith individual that is consistent with gᵢ.

For any i and k,

$$P ( {ψ}_{i} = {ω}_{i} \vert {d}_{i} = {a}_{k} , {q}_{+} , {q}_{-} ) = \{ \begin{matrix}{q}_{+} & if {ω}_{i} = {ψ}_{+} and {a}_{k} ∈ {D}_{+} \\ 1 - {q}_{+} & if {ω}_{i} \neq {ψ}_{+} and {a}_{k} ∈ {D}_{+} \\ {q}_{-} & if {ω}_{i} = {ψ}_{+} and {a}_{k} ∉ {D}_{+} \\ 1 - {q}_{-} & if {ω}_{i} \neq {ψ}_{+} and {a}_{k} ∉ {D}_{+}\end{matrix}$$

Under the null hypothesis that the phenotype is independent of the diplotype configuration concerning the loci examined, the likelihood function is

$$L ( Θ , {q}_{0} ) ∝ {\prod }_{i = 1}^{N} {\sum }_{{a}_{k} ∈ Ai}^{} P ( {ψ}_{i} = {w}_{i} \vert {d}_{i} = {a}_{k} , {q}_{0} ) P ( {d}_{i} = {a}_{k} \vert Θ ) , \qquad ( 2 )$$

where q₀ denotes the penetrance for all the diplotype configurations, and Aᵢ denotes the set of aₖ for the ith individual that is consistent with gᵢ.

For any i and k,

$$P ( {ψ}_{i} = {w}_{i} \vert {d}_{i} = {a}_{k} , {q}_{0} ) = \{ \begin{matrix}{q}_{0} & if {w}_{i} = {ψ}_{+} \\ 1 - {q}_{0} & if {w}_{i} \neq {ψ}_{+}\end{matrix}$$

<EM Algorithm>

Expression (1) shown above is maximized over Θ, q₊ and q₋, and the maximum likelihood thereby obtained is calculated as Lₘₐₓ. In the present algorithm, expression (2) is also maximized over Θ and q₀, and the maximum likelihood thereby obtained is calculated as L₀ₘₐₓ. The likelihood ratio L₀ₘₐₓ/Lₘₐₓ is used to test the association between the existence of the haplotype and the phenotype.

In the maximization for Lₘₐₓ, the parameters to be estimated are Θ=(θ₁, θ₂, . . . ,θ_{L}), q₊ and q₋, while in the maximization for L₀ₘₐₓ, the parameters to be estimated are Θ=(θ₁, θ₂, . . . , θ_{L}), q₀. The space spanned in the maximization for L₀ₘₐₓ is a subspace of that spanned in the maximization for Lₘₐₓ. Under the null hypothesis, −2log(L₀ₘₐₓ/Lₘₐₓ) follows the λ² distribution with the degree of freedom of 1.

If the complete data on d₁, d₂, . . . , d_{N} and ψ₁, ψ₂, . . . , ψ_{N} can be obtained, the maximum likelihood estimates of θ₁, θ₂, . . . , θ_{L} and q₊, q₋ can easily be obtained as
\hat{θ}j=nⱼ/(2N)
\hat{q}₊=N_{+ψ+}/N₊
\hat{q}₋=N_{-ψ+}/N₋
(where j=1, 2, . . . , L), where nⱼ is the number of copies of the jth haplotype in the N individuals. Also,
N₊=#{i;dᵢεD₊},
N₋=#{i;dᵢ∉D₊},
N_{+ψ+}=#{i;dᵢεD₊,ψᵢ=ψ₊}
N_{-ψ+}=#{i;dᵢ∉D₊,ψᵢ=ψ₊}
where #{i; , ,} denotes the number of individuals that fulfill the condition after “;”.

However, the complete data on the diplotype configurations of the individuals cannot be obtained, while we observe only the genotype data and the phenotype data on the individuals. Therefore, we prepares the following algorithm in which the expected values of nⱼ/(2N), N_{+ψ+}/N₊ and N_{-ψ-}/N are substituted for the real values. That is, the present algorithm includes the following steps (i) to (viii).
(i) For n=0, initial values (e.g., Θⱼ⁽ⁿ⁾=1/L) are given to Θ⁽ⁿ⁾=(Θ₁⁽ⁿ⁾, Θ₂⁽ⁿ⁾, . . . , Θ_{L}⁽ⁿ⁾) where

$${\sum }_{j = 1}^{L} {θ}_{j}^{( n )} = 1$$

θ_{L}⁽ⁿ⁾>0
(ii) For n=0, initial values are given to q₊⁽ⁿ⁾, q₋⁽ⁿ⁾ where 0<q₊⁽ⁿ⁾, q₋⁽ⁿ⁾<1.
(iii) For all i and for all aₖ consistent with the genotype gᵢ, the following calculation is performed:

$$\begin{matrix}P ( {d}_{i} = {a}_{k} \vert {g}_{i} , {ψ}_{i} = {ω}_{i} , {Θ}^{( n )} , {q}_{+}^{( n )} , {q}_{-}^{( n )} ) = \\ P ( {d}_{i} = {a}_{k} \vert {Θ}^{( n )} , {q}_{+}^{( n )} , {q}_{-}^{( n )} ) P ( {g}_{i} , {ψ}_{i} = {ω}_{i} \vert {d}_{i} = {a}_{k} , {Θ}^{( n )} , {q}_{+}^{( n )} , {q}_{-}^{( n )} ) / \\ {\sum }_{{a}_{m} ∈ {A}_{i}}^{} P ( {d}_{i} = {a}_{m} \vert {Θ}^{( n )} , {q}_{+}^{( n )} , {q}_{-}^{( n )} ) \\ P ( {g}_{i} , {ψ}_{i} = {ω}_{i} \vert {d}_{i} = {a}_{m} , {Θ}^{( n )} , {q}_{+}^{( n )} , {q}_{-}^{( n )} )\end{matrix} \qquad ( 3 )$$

where Aᵢ denotes the set of aₘ consistent with gᵢ. Note that in the present algorithm examination is made only with respect to aₖ consistent with gᵢ. In addition, since dᵢ is independent of q₊⁽ⁿ⁾ and q₋⁽ⁿ⁾, and ψᵢ is independent of Θ₍ₙ₎ conditionally on dᵢ, equation (3) shown above becomes

$$\begin{matrix}P ( {d}_{i} = {a}_{k} \vert {ψ}_{i} = {ω}_{i} , {Θ}^{( n )} , {q}_{+}^{( n )} , {q}_{-}^{( n )} ) \\ = P ( {d}_{i} = {a}_{k} \vert {ψ}_{i} = {Θ}^{( n )} , {q}_{+}^{( n )} , {q}_{-}^{( n )} ) \\ = P ( {d}_{i} = {a}_{k} \vert {Θ}^{( n )} ) P ( {ψ}_{i} = {ω}_{i} \vert {d}_{i} = {a}_{k} , {q}_{+}^{( n )} , {q}_{-}^{( n )} ) / \\ {\sum }_{{a}_{m} ∈ {A}_{i}}^{} P ( {d}_{i} = {a}_{m} \vert {Θ}^{( n )} ) P ( {ψ}_{i} = {ω}_{i} \vert {d}_{i} = {a}_{m} , {q}_{+}^{( n )} , {q}_{-}^{( n )} ) \end{matrix}$$
(iv) Since nⱼ, the number of haplotype copies of the jth haplotype possessed by N individuals is a random variable, we can define the expected number of haplotype copies of the jth haplotype as

$$\begin{matrix}E [ {n}_{j} \vert {Ψ}_{obs} , {G}_{obs} , {Θ}^{( n )} , {q}_{+}^{( n )} , {q}_{-}^{( n )} ] = \\ {\sum }_{i = 1}^{N} {\sum }_{{a}_{k} ∈ {A}_{i}}^{} {f}_{i} ( {a}_{k} ) P ( {d}_{i} = {a}_{k} \vert {ψ}_{i} = {ω}_{i} , {Θ}^{( n )} , {q}_{+}^{( n )} , {q}_{-}^{( n )} ) .\end{matrix}$$

where fⱼ(aₖ) denotes the number of haplotype copies of the jth haplotype in aₖ, and Aᵢ, again, denotes the set of aₖ consistent with gᵢ concerning the ith individual. Note that fⱼ(aₖ) is either 0, 1, or 2. The expected values are calculated for all j.
(v) Since N_{+ψ+}/N₊ and N_{-ψ-}/N are random variables, the expected values can be defined as

$$\begin{matrix}\begin{matrix}E [ {N}_{+ ψ +} / {N}_{+} \vert {Ψ}_{obs} , {G}_{obs} , {Θ}^{( n )} , {q}_{+}^{( n )} , {q}_{-}^{( n )} ] \\ = {\sum }_{i = 1}^{N} {\sum }_{{a}_{k} ∈ {D}_{+}}^{} {y}_{i} P ( {d}_{i} = {a}_{k} \vert {ψ}_{i} = {ω}_{i} , {g}_{i} , {Θ}^{( n )} , {q}_{+}^{( n )} , {q}_{-}^{( n )} ) / \\ {\sum }_{i = 1}^{N} {\sum }_{{a}_{k} ∈ {D}_{+}}^{} P ( {d}_{i} = {a}_{k} \vert {ψ}_{i} = {ω}_{i} , {g}_{i} , {Θ}^{( n )} , {q}_{+}^{( n )} , {q}_{-}^{( n )} ) \\ and \end{matrix} \\ \begin{matrix}E [ {N}_{- ψ -} / {N}_{-} \vert {Ψ}_{obs} , {G}_{obs} , {Θ}^{( n )} , {q}_{+}^{( n )} , {q}_{-}^{( n )} ] \\ = {\sum }_{i = 1}^{N} {\sum }_{{a}_{k} ∈ {D}_{+}}^{} {y}_{i} P ( {d}_{i} = {a}_{k} \vert {ψ}_{i} = {ω}_{i} , {g}_{i} , {Θ}^{( n )} , {q}_{+}^{( n )} , {q}_{-}^{( n )} ) / \\ {\sum }_{i = 1}^{N} {\sum }_{{a}_{k} ∈ {D}_{+}}^{} P ( {d}_{i} = {a}_{k} \vert {ψ}_{i} = {ω}_{i} , {g}_{i} , {Θ}^{( n )} , {q}_{+}^{( n )} , {q}_{-}^{( n )} )\end{matrix}\end{matrix}$$

where

$${y}_{i} = \{ \begin{matrix}1 & if {ω}_{i} = {ψ}_{+} \\ 0 & if {ω}_{i} \neq {ψ}_{+}\end{matrix}$$
(vi) From the calculation of step (iv), Θ is updated for the next step as follows.
   θⱼ⁽ⁿ⁺¹⁾E[nⱼ|Ψ_{obs},G_{obs}, θ⁽ⁿ⁾,q₊⁽ⁿ⁾,q₋⁽ⁿ⁾]/(2N)

From the calculation of step (v), the penetrances are updated for the next step as follows.
q₊⁽ⁿ⁺¹⁾=E[N_{+ψ+}/N₊|Ψ_{obs}, G_{obs}, θ⁽ⁿ⁾,q₊⁽ⁿ⁾,q₋^{(n)]}
q₋⁽ⁿ⁺¹⁾=E[N_{-ψ+}/N₋|Ψ_{obs}, G_{obs}, θ⁽ⁿ⁾,q₊⁽ⁿ⁾,q₋^{(n)]}
(vii) The steps (iii) through (vi) are repeated until the values converge.

The values when converged are considered as the maximum likelihood estimates:

\hat{Θ}=(\hat{θ}₁,\hat{θ}₂, . . . \hat{θ}_{L})

\hat{q}₊

\hat{q}₋

(viii) To avoid the local maximum, different sets of values for the initial values Θⱼ⁽⁰⁾ (j=1, 2, . . . , L), q₊⁽⁰⁾, q₋⁽⁰⁾ are tested.

Here,
P(Ψ_{obs},G_{obs}|\hat{θ},\hat{q}₊,\hat{q}₋)
   is the maximum likelihood Lₘₐₓ for the alternative hypothesis.

If the condition q₀=q₊=q₋ is given and if the steps (iii) through (vii) are repeated, then the maximum likelihood L₀ₘₐₓ for the alternative hypothesis is obtained.

Under the null hypothesis, the statistic −2log(L₀ₘₐₓ/Lₘₐₓ) is expected to asymptotically follow the λ² distribution with the degree of freedom of 1.

<Phenotype Development Probability Estimation Algorithm>

By the above-described EM algorithm (the present algorithm), the probability that a specimen develops a predetermined phenotype can be estimated on the basis of genotype data on the specimen. Let the specimen to be examined be N+1, and let g_{N+1} denote the observed genotype of this specimen. The probability that the specimen develops the phenotype ψ₊:

P(ψ_{N+1}=ψ₊|g_{N+1}, \hat{θ})

can be estimated by the following equation:

$$P ( {ψ}_{N + 1} = {ψ}_{+} \vert {g}_{N + 1} , \hat{Θ} ) = {\hat{q}}_{+} {\sum }_{{a}_{k} ∈ {D}_{+}}^{} P ( {d}_{N + 1} = {a}_{k} \vert {g}_{N + 1} , \hat{Θ} ) + {\hat{q}}_{-} {\sum }_{{a}_{k} ∉ {D}_{+}}^{} P ( {d}_{N + 1} = {a}_{k} \vert {g}_{N + 1} , \hat{Θ} )$$

where d_{N+1} denotes the diplotype configuration for N+1th specimen.

The above-described EM algorithm and phenotype development probability estimation algorithm (the present algorithm) can be implemented, for example, in a computer program. If the present algorithm is implemented in a computer program, all calculations can be performed in a computer.

The computer in which the software having the present algorithm implemented therein is installed may be connected to an external network via a communication network, for example, to enable genotype data and phenotype data obtained from a cohort study or a clinical trial to be obtained via the communication network as well as to enable penetrances and probabilities obtained by the present algorithm to be output via the communication network.

2. Application to Case-Control Study

Description will next be made of a method in which genotype data and phenotype data on individuals obtained as a result of a case-control study are used in the above-described algorithm to test the association between the existence of a phenotype and a haplotype and to estimate the penetrance based on the haplotype.

In a case-control study, cases and controls are sampled by fixing the number of cases (affected) and the number of controls (non-affected). Therefore, if the ratio of cases and controls is “case:control=ω: 1−ω” and if the proportion of affected specimens in the entire population (incidence rate) is λ, cases corresponding to ω in the affected specimens (λ) in the sample space and controls corresponding to (1−ω) in the non-affected specimens (1−λ) in the sample space are extracted.

Accordingly, if the condition of an individual as to whether or not the individual has an element in D₊ of diplotype configurations is associated with the existence/nonexistence of a particular phenotype (e.g., a particular disease) in a case-control study, parameters estimated in the case-control study are given as shown in Table 1 below.

TABLE 1

| | dᵢ ∈ Dᵢ | dᵢ ∉ D₊ | |
|---|---|---|---|
| | D₁ . . . Dₖ | ${D}_{k + 1} … {D}_{{H}^{2}}$ | Total |
| case | ${f}_{{D}_{1} {r}_{+}}^{′} {…f}_{{D}_{k} {r}_{+}}^{′}$ | ${f}_{{D}_{k + 1}}^{′} {r}_{-} … {f}_{{D}_{{H}^{2}}}^{′} {r}_{-}$ | ω |
| control | ${f}_{{D}_{1}}^{′} ( 1 - {r}_{+} ) … {f}_{{D}_{k}}^{′} ( 1 - {r}_{+} )$ | ${f}_{{D}_{k + 1}}^{′} ( 1 - {r}_{-} ) … {f}_{{D}_{{H}^{2}}}^{′} ( 1 - {r}_{-} )$ | 1 − ω |
| Total | ${f}_{{D}_{1}}^{′} … {f}_{{D}_{k}}^{′}$ | ${f}_{{D}_{k + 1}}^{′} … {f}_{{D}_{{H}^{2}}}^{′}$ | ${\sum }_{k}^{{H}^{2}} {f}_{{D}_{k}}^{′} = 1$ |

In the above Table 1, ω is a constant and

f′_{D}

denotes the frequencies of diplotype configurations in the population including cases and controls. Unlike penetrances q₊ and q₋ estimated in the above-described case of application to a cohort study or a clinical trial, r₊ and r₋ do not denote penetrances. The relationship between these estimates can be shown by the following equation:

$$ω = {r}_{+} {\sum }_{j = 1}^{k} {f}_{{D}_{j}} + {r}_{-} {\sum }_{j = k + 1}^{{H}^{2}} {f}_{{D}_{j}}$$

It can be understood from the above equation that r₊ and r₋ are not in a mutually dependent relationship, and that the number of estimated parameters in the case of application of the present algorithm to a case-control study is smaller by one than that in the above-described case of application to a cohort study or a clinical trial. The relationship r₊=r₋ is established when r₊=r=w. Therefore, the null hypothesis and the alternative hypothesis in the case of application of the present algorithm to a case-control study are

H₀:r₊=ω

H₁:r₊≠ω

Also, the penetrance q₊ is expressed by using the estimate r₊ as

$${q}_{+} = \frac{1}{\frac{ω}{( 1 - ω )} \frac{( 1 - {r}_{+} )}{{r}_{+}} \frac{( 1 - λ )}{λ} + 1}$$

In a case-control study, therefore, an estimate of the penetrance can be computed by using a result of the case-control study. Thus, the estimate of the penetrance is calculated by substituting the estimate r₊ estimated by applying the present algorithm to the case-control study.

The incidence rate λ cannot be estimated from any result of a case-control study, and therefore needs to be separately given. For example, the incidence rate λ may be obtained as a particular value from a statistical investigation of a target disease or a follow-up survey in a particular population.

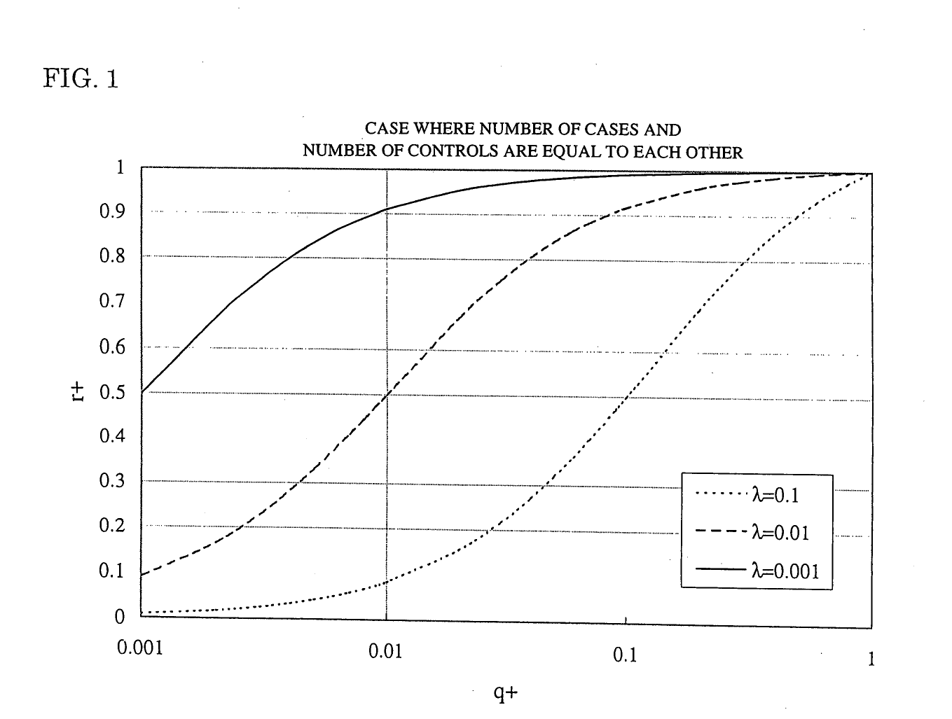

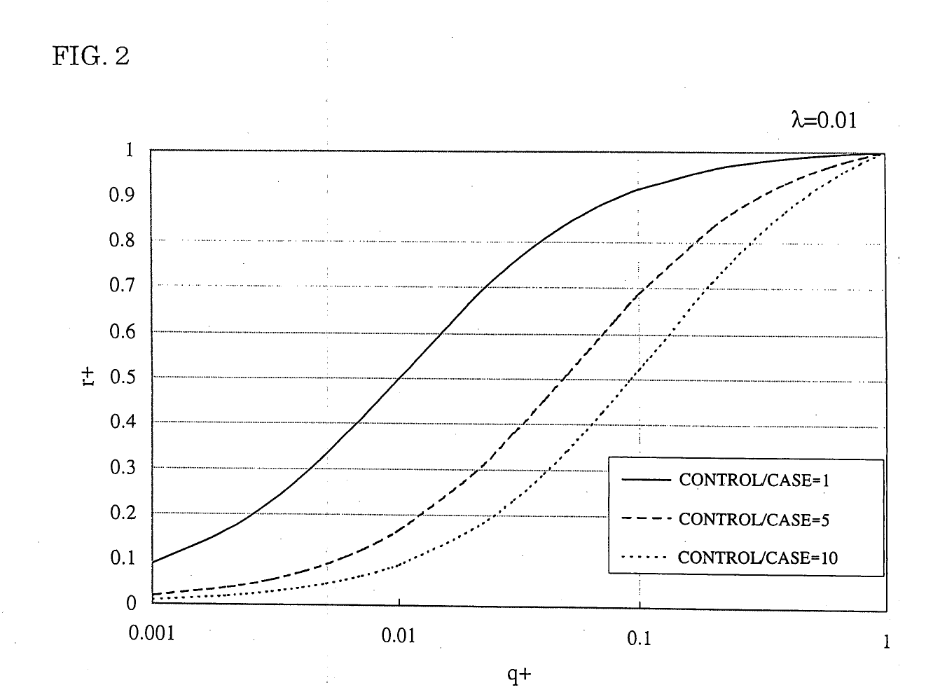

FIGS. 1 and 2 show the relationship between r₊ and q₊ based on the above-described equation showing the relationship between r₊ and q₊. FIG. 1 is a characteristic diagram showing a case where the value of λ is set to 0.1, 0.01 and 0.001 when the number of cases and the number of controls are equal to each other. FIG. 2 is a characteristic diagram showing a case where λ is set to 0.01 and the ratio of cases and controls (case/control) is set to 1, 5, and 10.

Even in the case of use of results of a case-control study, the probability of development of a predetermined phenotype in specimens can be estimated on the basis of genotype data on the specimens, as is that in the above-described case of use of results of a cohort study or a clinical trial.

<Simulation>

In the following description,
\hat{Θ}
\hat{q}₊
\hat{q}₋
   are referred to as “Θ hat”, “q₊ hat” and “q₋ hat”, respectively.
   Empirical Distribution of the Statistic −2log(L₀ₘₐₓ/L_{Max}) Under the Null Hypothesis

We first examined the empirical distribution of the statistic −2log(L₀ₘₐₓ/Lₘₐₓ) under the null hypothesis by a simulation. In this examination, we obtained the haplotype frequency Θ not by a simulation but from real data. That is, we used Θ obtained from a study made in the past on SAA (serum amyloid A) genes [Moriguchi et al. (2001) A novel single-nucleotide polymorphism at the 5′-flanking region of SAA1 associated with risk of type AA amyloidosis secondary to rheumatoid arthritis. Arthritis Rheum 44: 1266-1272]. For q₀, we tested various values between 0 and 1. Note that under the null hypothesis the penetrance is the same for all the diplotype configurations.

We began the simulation by giving ordered two haplotype copies to each of N individuals by drawing haplotypes using Θ, and determined the phenotype of each individual according to q₀. Thus, q₀ was used as the probability at which an arbitrary one of the individuals develops the phenotype ψ₊. After removing the phase information, the algorithm as defined above was applied to the simulated data for determination of the statistic −2log(L₀ₘₐₓ/Lₘₐₓ). The simulation was repeatedly performed and the distribution of the statistic was examined.

Haplotype data on SAA gene includes six SNP data items. Table 2 shows haplotypes and frequencies relating to SAA gene.

TABLE 2

| | | | |
|---|---|---|---|
| Haplotype | Frequency | Haplotype | Frequency |

| | | | |
|---|---|---|---|
| ACTGCC | 0.394 | AGCACT | 0.018 |
| ACCGTC | 0.214 | GGCGCT | 0.017 |
| AGCGCT | 0.210 | ACTGTC | 0.013 |
| GCCGTC | 0.036 | ACCGCC | 0.006 |
| GCTGCT | 0.035 | ACCATC | 0.006 |
| GGCACT | 0.023 | AGCGCC | 0.003 |
| ACTGCT | 0.023 | | |

In the above Table 2, the haplotype “ACCGTC” is a haplotype assigned as “phenotype-associated haplotype” in a simulation according to the alternative hypothesis.

On the basis of Table 2, haplotype copies were randomly drawn to give ordered two haplotype copies to each individual. Since the probability of development of the phenotype ψ is the same with respect to all the individuals, the phenotype ψ was given on the basis of the probability q₀ fixed for each individual. Various values from 0 to 1 were given as q₀.

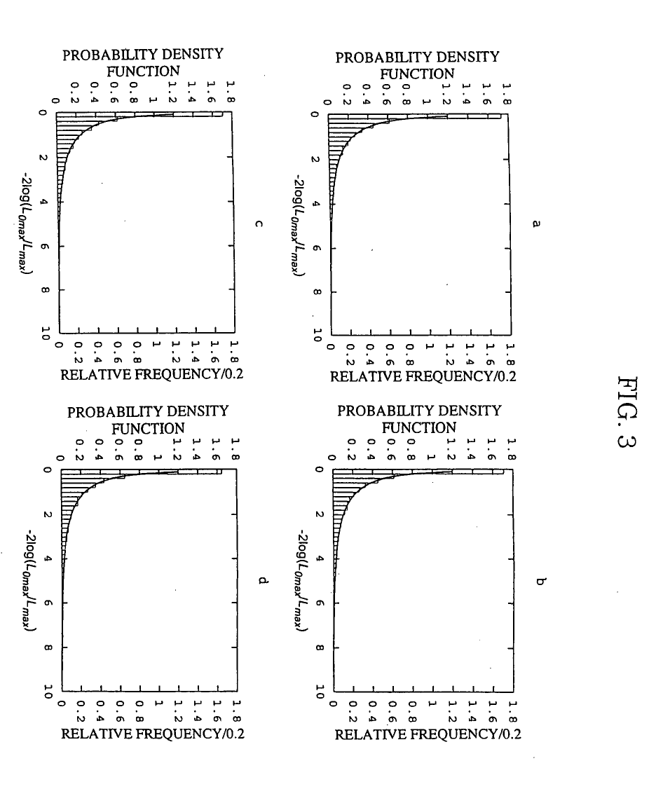

FIG. 3 is a histogram showing the distributions of the statistic −2log(L₀ₘₐₓ/Lₘₐₓ) at various values of q₀ and N. The graph “a” in FIG. 3 shows the results when q₀=0.2 and N=1,000; the graph “b” the results when q₀=0.1 and N=1,000; the graph “c” the results when q₀=0.2 and N=200; and the graph “d” the results when q₀=0.2 and N=100. The graphs in FIG. 3 comprise bar graphs plotted as histograms of the statistic, and curves representing the probability density function of the λ² distribution with the degree of freedom of 1.

Table 3 shows, with respect to various values given as q₀ and N, the probability of the type I error (α=0.05) calculated by assuming the distribution of the statistic follows the λ² distribution with the degree of freedom of 1, and the values of “q₊ hat” and “q₋ hat” estimated under the alternative hypothesis.

TABLE 3

| | Sample | | | Type I |
|---|---|---|---|---|
| q₀ | size N | q₊ hat | q₋ hat | error rate^{b} |
| 0.2 | 1000 | 0.20025 ± 0.02085 | 0.20000 ± 0.01625 | 0.05060 |
| 0.1 | 1000 | 0.09996 ± 0.01570 | 0.10008 ± 0.01241 | 0.05580 |
| 0.2 | 200 | 0.19929 ± 0.04719 | 0.29973 ± 0.03654 | 0.05040 |
| 0.2 | 100 | 0.19987 ± 0.06644 | 0.20118 ± 0.05238 | 0.05640 |
| 0.4 | 100 | 0.39986 ± 0.08245 | 0.40040 ± 0.06400 | 0.05980 |
| 0.5 | 100 | 0.50117 ± 0.08471 | 0.49938 ± 0.06418 | 0.05280 |

In the above Table 3, the values of “q₊ hat” and “q₋ hat” are shown as mean±standard deviation. As the type I error rate, the rate at which the value of the statistic exceeded 3.841 (at which the cumulative density function of the λ² distribution with the degree of freedom of 1 is 0.95) is shown.

It is apparent from the results shown in FIG. 3 and Table 3 that this statistic asymptotically follows the λ² distribution with the degree of freedom of 1 under the null hypothesis.

Simulation Under the Alternative Hypothesis:

Next, the simulation under the alternative hypothesis was performed. One of the haplotypes was assumed to be associated with the phenotype ψ₊, and this phenotype was denoted as “phenotype-associated haplotype”. For this simulation, D₊ was defined as the set of diplotype configurations that contained at least one “phenotype-associated haplotype”. Various from 0 to 1 were given as each of the two penetrances q₊ and q₋.

The simulation was began by giving each individual ordered two haplotype copies by drawing them using Θ. Then q₊ or q₋ was given as the probability of development of the phenotype ψ₊ in each individual. The probability of development of phenotype ψ₊ when the individual had the “phenotype-associated haplotype” was q₊, while the probability of development of phenotype ψ₊ when the individual did not have the “phenotype-associated haplotype” was q₋.

After removing the phase information, the genotype and the phenotype data were subjected to the above defined algorithm. The simulation was repeated many times and the results obtained were analyzed. The power was estimated at various values of q₊ and q₋ by assuming that under the null hypothesis the statistic −2log(L₀ₘₐₓ/Lₘₐₓ) follows the λ² distribution with the degree of freedom of 1.

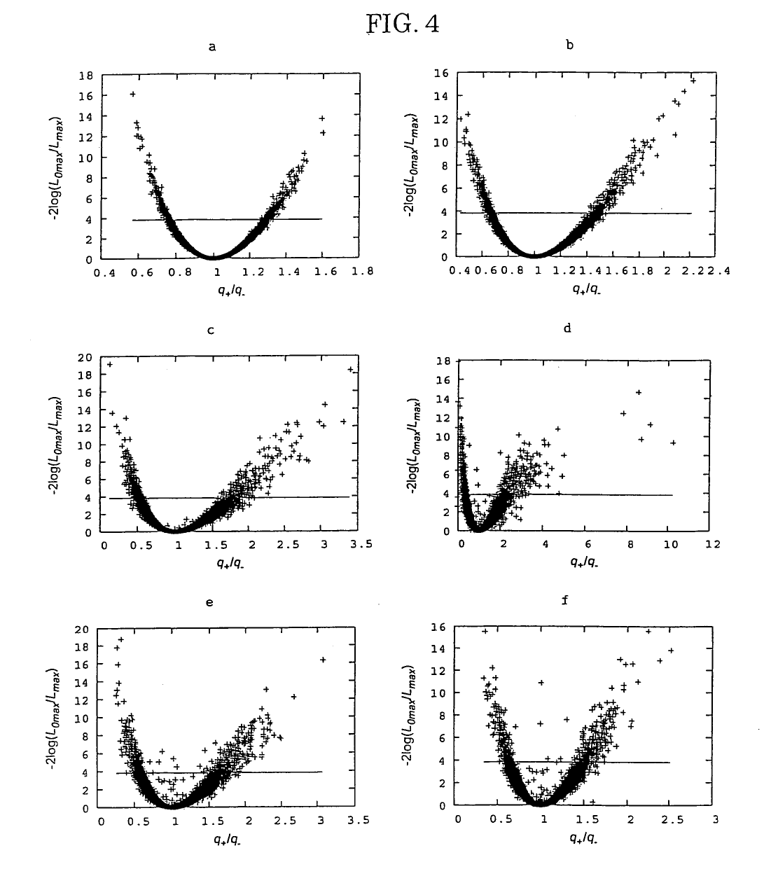

FIG. 4 shows the distributions of the statistic obtained by changing the value of q₊/q₋ (i.e., the relative risk) while fixing the value of q₊. In FIG. 4, the graphs a to f show the results of calculation of the statistic performed by setting conditions shown below and by changing the value of q₋.
(a) q₊=0.2, N=1,000
(b) q₊=0.1, N=1,000
(c) q₊=0.2, N=200
(d) q₊=0.2, N=100
(e) q₊=0.4, N=100
(f) q₊=0.5, N=100

In the graphs a to f in FIG. 4, the horizontal line at the value 3.831 indicates a limit value (P=0.05) in the case where the statistic follows the λ² distribution with the degree of freedom of 1.

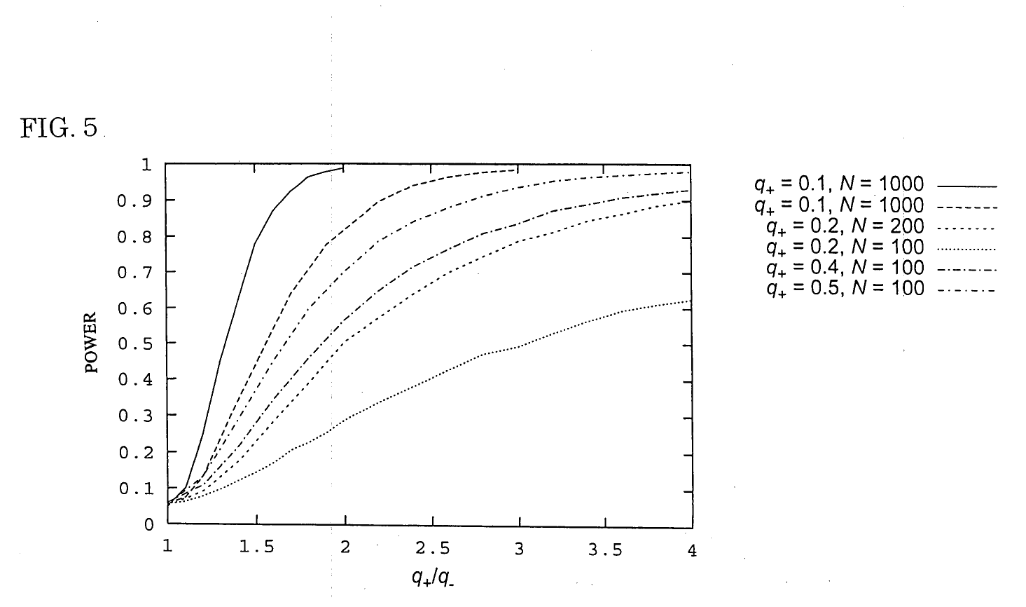

The same simulation was repeated 10,000 times by setting various values of q₊, q₋ and N and the proportion of trials resulting in a state where the value of the statistic exceeded 3.841 (at which the cumulative density function of the λ² distribution with the degree of freedom of 1 is 0.95) was obtained as an empirical power. FIG. 5 shows the results of the simulation showing that the power increases with the increase in q₊/q₋ (q₊/q₋≧1) (i.e., the relative risk) and with the increase in N.

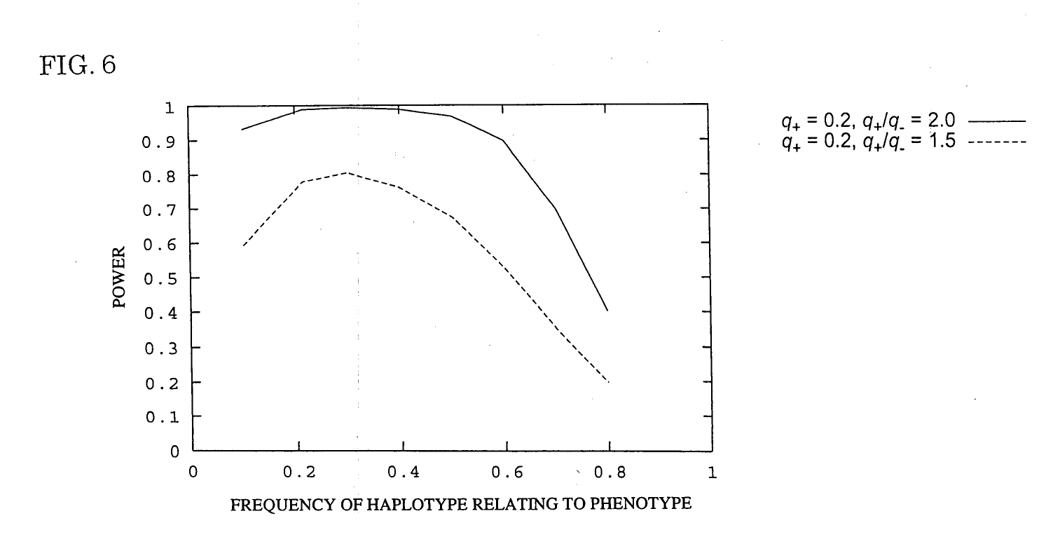

FIG. 6 shows the results of examination of the frequency of the “phenotype-associated haplotype” on the statistic. From FIG. 6, it was made clear that the power has a peak at an at an intermediate value of the frequency of the “phenotype-associated haplotype” between 0 and 1.

Distribution of Estimated Penetrances “q₊ hat” and “q₋0 hat”:

The distributions of “q₊ hat” and “q₋0 hat” were examined under the above-described alternative hypothesis. More specifically, the distributions were examined under the condition of changing the penetrance q₋ to the given penetrance q₊=0.2. The relative risk (q₊/q₋) was changed from 1.0 to 2.0. The sample size N was fixed at 1,000. By using the present algorithm, “q₊ hat” and “q₋ hat” were estimated under the alternative hypothesis and the statistic −2log(L₀ₘₐₓ/Lₘₐₓ) was calculated. This simulation was repeated 10,000 times with respect to each parameter. Table 4 shows the results of this simulation.

TABLE 4

| | q₊ hat | q₋ hat | |
|---|---|---|---|
| | (mean ± standard | (mean ± standard | Empirical |
| Q₊/q₋ | deviation) | deviation) | detection rate^{b} |
| 1.0 | 0.20025 ± 0.02085 | 0.20000 ± 0.01625 | 0.05060 |
| 1.1 | 0.19958 ± 0.02056 | 0.18202 ± 0.01568 | 0.10070 |
| 1.2 | 0.19999 ± 0.02076 | 0.16722 ± 0.01518 | 0.24860 |
| 1.3 | 0.20020 ± 0.02078 | 0.15390 ± 0.01447 | 0.45060 |
| 1.4 | 0.19968 ± 0.02098 | 0.14314 ± 0.01432 | 0.61810 |
| 1.5 | 0.20008 ± 0.02074 | 0.13298 ± 0.01377 | 0.77940 |
| 1.6 | 0.20003 ± 0.02077 | 0.12499 ± 0.01340 | 0.86990 |
| 1.7 | 0.19998 ± 0.02066 | 0.11807 ± 0.01315 | 0.92470 |
| 1.8 | 0.20021 ± 0.02060 | 0.11083 ± 0.01272 | 0.96390 |
| 1.9 | 0.20007 ± 0.02046 | 0.10493 ± 0.01265 | 0.97860 |
| 2.0 | 0.20003 ± 0.02059 | 0.09990 ± 0.01236 | 0.98910 |

In Table 4, “q₊ hat” and “q₋ hat” are shown as mean±standard deviation, and the empirical detection rate is shown as the proportion of trials resulting in a state where the value of the statistic exceeded 3.841 (at which the cumulative density function of the λ² distribution with the degree of freedom of 1 is 0.95). As shown in Table 4, it has been made clear that q₊ and q₋ can be estimated with substantially high accuracy by the present algorithm and the variation is comparatively small. From this result, it is thought that the accuracy of each of the estimate of q₊/q₋, “q₊ hat” and “q₃₁ hat” is comparatively high.

We also examined whether “Θ hat” and the posterior probability distribution of the diplotype configuration (diplotype distribution) when they were estimated by factoring in the phenotype data were the same as those estimated without factoring in the phenotype data. The estimation without the phenotype data was performed by the program, so-called LDSUPPORT. By program LDSUPPORT, the diplotype distribution is estimated from the genotype data only. However, the penetrances are set as q₀=q₊=q₋, i.e., under the null hypothesis, the estimated “Θ hat” and the diplotype distribution of each individual were the same as those estimated by LDSUPPORT. “q₊ hat” and “q₋ hat” were changed when the phenotypes of the individuals were changed, although no data on this change is shown here.

Table 5 shows the result of the simulation performed under the alternative hypothesis by using Θ obtained from SAA gene shown in Table 2. The parameters in the simulation are q₊=0.2, q₋=0.1 and N=1,000. Table 5 shows data on four typical subjects.

TABLE 5

Diplotype distribution^{b}

| | | |
|---|---|---|
| Diplotype | Only | Phenotype is |

| | | | | | |
|---|---|---|---|---|---|
| Subject | Phenotype^{a} | configuration | genotypes^{c} | + Phenotype^{d} | changed^{e} |

| | | | | | |
|---|---|---|---|---|---|
| SUBJ00011 | N | AGCGCT GCCGTC | 0.6267 | 0.6417 | 0.5345 |
| | | ACCGTC GGCGCT | 0.3733 | 0.3583 | 0.4655 |
| SUBJ00074 | N | AGCACT GCTGCT | 0.6228 | 0.6213 | 0.6214 |
| | | ACTGCT GGCACT | 0.3772 | 0.3786 | 0.3785 |
| | | AGCGCT GCTACT | — | 0.0001 | 0.0001 |
| SUBJ00092 | A | AGCGCT GCCGTC | 0.6267 | 0.5360 | 0.6432 |
| | | ACCGTC GGCGCT | 0.3733 | 0.4640 | 0.3568 |
| SUBJ00222 | N | ACCGTC GGCACT | 0.8734 | 0.8666 | 0.8666 |
| | | AGCACT GCCGTC | 0.1044 | 0.1098 | 0.1098 |
| | | ACCATC GGCGCT | 0.0222 | 0.0235 | 0.0235 |
| | | AGCGCC GCCATT | 0.0001 | 0.0001 | 0.0001 |

In the column “Phenotype” of Table 5, the affected states of the subjects are shown. N denotes non-affected subjects, and A denotes affected subjects. In the columns “Diplotype distribution” of Table 5, the posterior distribution of the diplotype configuration of each individual is shown. In particular, in the column “Only genotype”, the results of analysis performed by using LDSUPPORT without phenotype information are shown. In the column “+ Phenotype”, the results of analysis performed by the present algorithm using the genotype data and the phenotype data are shown. In the column “Phenotype is changed”, the results of analysis performed by the present algorithm using data obtained by inverting only the phenotype data on the individuals are shown.

As shown in Table 5, the diplotype configuration of each individual estimated as “Θ hat” was actually changed by factoring in the phenotype data or changing the phenotype of the individual. In a case where the estimated diplotype distributions of the individuals were concentrated on one event, “Θ hat” and the diplotype distributions of the individuals were not substantially changed, although data on such a phenomenon is not shown in Table 5. In contrast, in a case where the diplotype distributions of the individuals were not concentrated on one event as shown in Table 4, “Θ hat” and the diplotype distributions of the individuals were changed by factoring in the phenotype data or changing the phenotypes of the individuals.

Next, a test was performed as to which of the present algorithm and the algorithm not factoring in phenotypes was higher in accuracy when both or one of “Θ hat” and the diplotype configuration estimated by factoring in phenotypes (i.e., by the present algorithm) was different from that estimated without factoring in the phenotypes (i.e., by the program LDSUPPORT).

More specifically, when a simulation was performed under the alternative hypothesis, Θ was obtained from SAA gene and a gene artificially designed. For the gene artificially designed, data on six SNP loci between which weak linkage disequilibrium exists was prepared and a collection of haplotype copies was formed.

The simulation of SAA gene using q₊=0.5, q₃₁ =0.125 and N=100 were set as parameters was performed 10,000 times. In the simulation of the artificial gene, the parameters were q₊=0.5 and N=1,000 and the value of q₋ was changed. This simulation was performed 1,000 times.

After each simulation, the phase information was removed and the data was subjected to the present algorithm. With respect to each individual, the true diplotype configuration and the estimated diplotype distribution were compared and a case where the true diplotype configurations coincides with the estimated diplotype distribution with the highest probability was recognized as accurate estimation. The proportion of the individuals for which diplotype configuration estimation was performed with accuracy as recognized by this comparison was recorded. The results of this test are shown in Table 6.

TABLE 6

| | | Accuracy of estimation^{a} | |
|---|---|---|---|
| Gene | q₊/q₋ | Only Genotypes | Phenotype data is added |
| SAA | 4.0 | 0.9692 ± 0.0912 | 0.9715 ± 0.0181 |
| Artificial | 2.0 | 0.8236 ± 0.0127 | 0.8365 ± 0.0122 |
| | 3.0 | 0.8235 ± 0.0126 | 0.8449 ± 0.0118 |
| | 4.0 | 0.8235 ± 0.0127 | 0.8491 ± 0.0115 |
| | 5.0 | 0.8236 ± 0.0128 | 0.8516 ± 0.0116 |

As shown in Table 6, the proportion of individuals for which the diplotype configuration was correctly estimated was increased in the case where the phenotype data was added (in the case where the present algorithm was used). It is thereby made clear that the accuracy of inference of the diplotype configuration can be improved by using the present algorithm.

Case-Control Study, Examination about Type I Error in Null Hypothesis

Type I error in the null hypothesis in the case of a case-control study was evaluated by a simulation using the present algorithm on the basis of haplotype frequencies of SAA gene (in Table 2 shown above) and haplotype frequencies of a gene artificially made and having weak linkage disequilibrium (hereinafter referred to briefly as ART). The haplotype frequencies used in this simulation are shown in Table 7.

TABLE 7

| SAA | | ART | |
|---|---|---|---|
| Haplotype | Frequency | Haplotype | Frequency |

| | | | |
|---|---|---|---|
| ACTGCC | 0.394 | 212122 | 0.1672 |
| ACCGTC | 0.214 | 221122 | 0.1428 |
| AGCGCT | 0.21 | 121122 | 0.1281 |
| GCCGTC | 0.036 | 221111 | 0.1164 |
| GCTGCT | 0.035 | 121111 | 0.1018 |
| GGCACT | 0.023 | 212111 | 0.0864 |
| ACTGCT | 0.023 | 221211 | 0.0766 |
| AGCACT | 0.018 | 221222 | 0.0759 |
| GGCGCT | 0.017 | 211122 | 0.0319 |
| ACTGTC | 0.013 | 211111 | 0.0314 |
| ACCGCC | 0.006 | 212222 | 0.025 |
| ACCATC | 0.006 | 212211 | 0.0165 |
| AGCGCC | 0.003 | | |

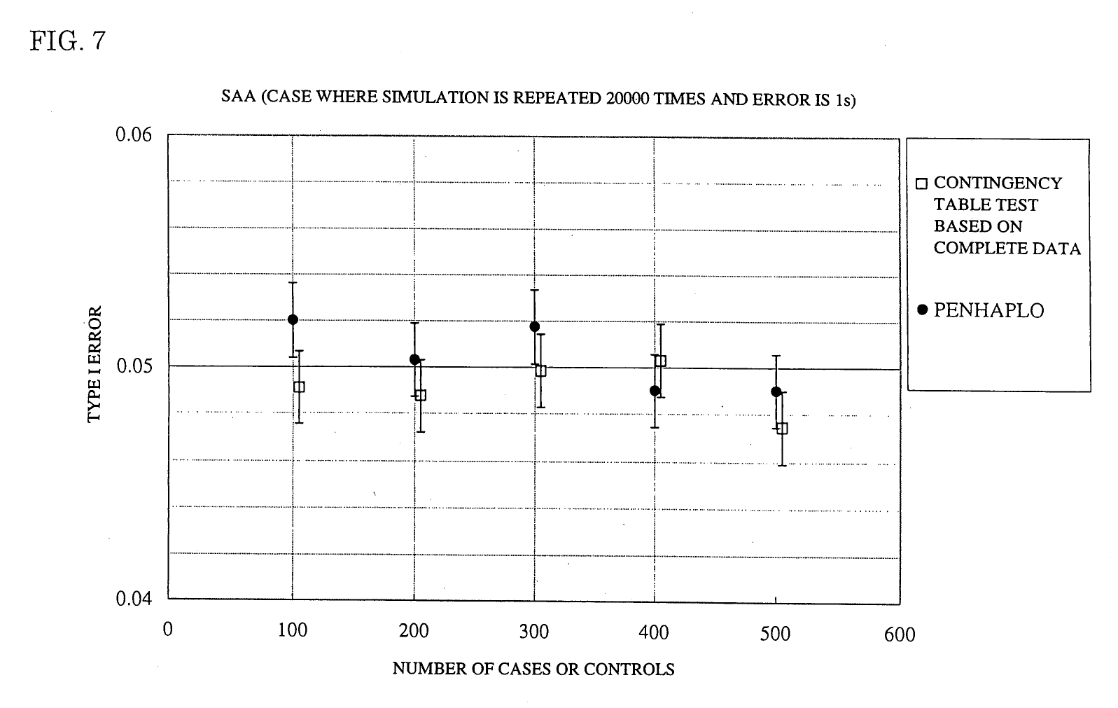

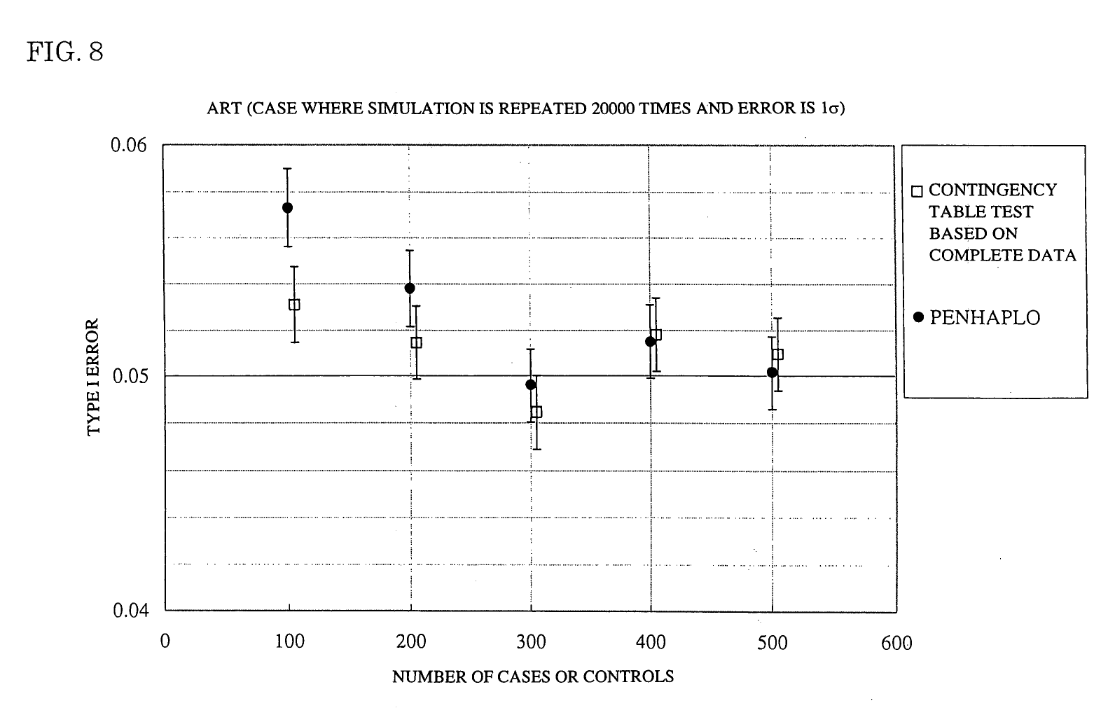

FIGS. 7 and 8 show the values of type I error obtained as a result of the simulation based on the two groups of haplotype frequencies shown in Table 7. FIG. 7 is a characteristic diagram showing the results in the case of using the haplotype frequency data on SAA gene, and FIG. 8 is a characteristic diagram showing the results in the case of using the haplotype frequency data on ART. In FIGS. 7 and 8, error bars indicating the λ² value according to the present algorithm and the λ² value according to a contingency table based on the complete data are shown in a shifted state for ease of recognition of the error bars.

From FIG. 7, it can be confirmed that the type I error coincides with the level of significance 0.05 in the range of statistical error when the number of samples is equal to or larger than 400 (cases=controls=200) in the case of using the haplotype frequency data on SAA gene, and when the number of samples is equal to or larger than 600 (cases=controls=300) in the case of using the haplotype frequency data on ART.

In a case where genotype data and phenotype data on individuals obtained as a result of a case-control study are used in the present algorithm, advantages described below can be obtained over methods of performing diplotype configuration estimation on individuals and thereafter performing a test by using a contingency table. Comparison with the following four methods of determining the diplotype configurations of individuals will be made.

1. Diplotype configuration estimation is separately performed on each of a case population and a control population. If a plurality of diplotype configurations can exist for each individual, one of them having the maximum probability is adopted as the diplotype configuration for the individual. (This method will be referred to as separate0.)

2. Diplotype configuration estimation is separately performed on each of a case population and a control population. If a plurality of diplotype configurations can exist for the individuals, the individuals are divided according to the probabilities of the diplotype configurations. (This method will be referred to as separate1.)

3. Diplotype configuration estimation is performed on the entire population comprising a case population and a control population, and the diplotype configuration having the maximum probability is adopted as the diplotype configuration of the corresponding individual. (This method will be referred to as separate2.)

4. Diplotype configuration estimation is performed on the entire population comprising a case population and a control population, and the individuals are divided according to the probabilities of diplotype configurations. (This method will be referred to as separate3.)

The Peason test statistic was calculated from contingency tables formed on the basis of the above-described separate0 to separate3 methods. The Peason test statistic obtained from a contingency table formed on the basis of the complete data on diplotype configurations (denoted as diplotype) and the likelihood ratio test statistic obtained by the present algorithm (denoted as Penhaplo) were also computed and correlation coefficients for these statistics were examined. Table 8 shows the results of simulations based on the haplotype frequencies of ART shown in Table 7.

TABLE 8

| | diplotype | Penhaplo | Separate0 | separate1 | separate2 | separate3 |
|---|---|---|---|---|---|---|
| diplotype | 1.000 | 0.712 | 0.337 | 0.544 | 0.569 | 0.708 |
| penhaplo | | 1.000 | 0.499 | 0.780 | 0.845 | 0.992 |
| separate0 | | | 1.000 | 0.806 | 0.473 | 0.483 |
| separate1 | | | | 1.000 | 0.693 | 0.765 |
| separate2 | | | | | 1.000 | 0.839 |
| separate3 | | | | | | 1.000 |

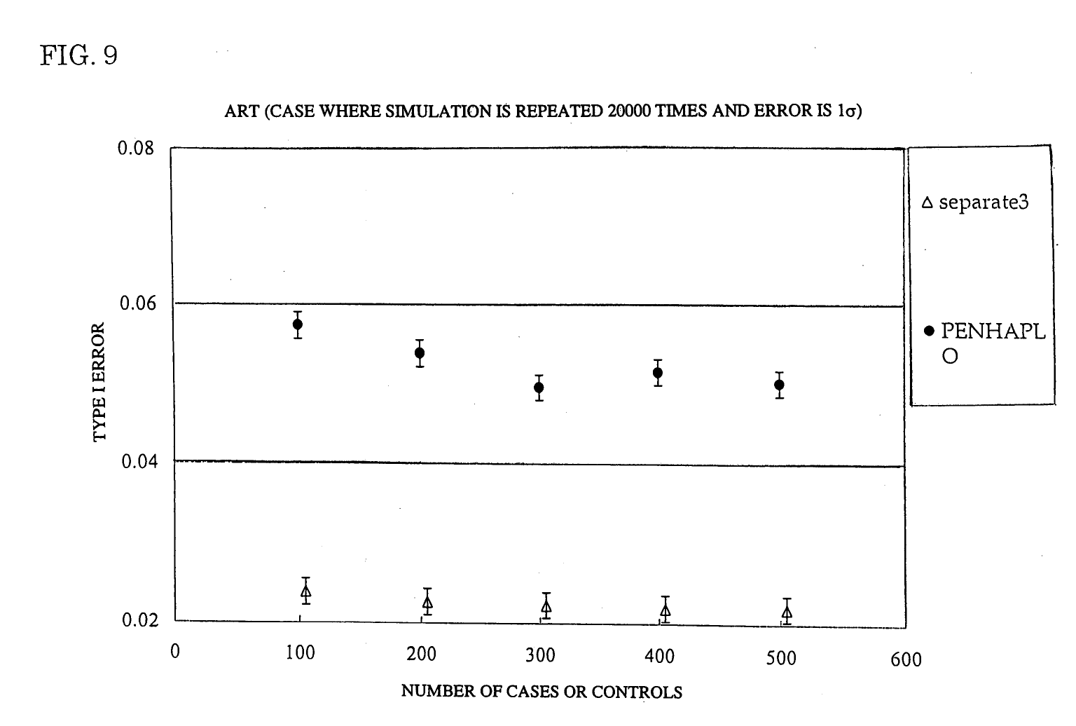

As can be understood from Table 8, the likelihood ratio test statistic (Penhaplo) obtained by the present algorithm shows the strongest correlation with the test statistic (diplotype) based on the complete data, and the statistic obtained by the separate3 division method shows the second strongest correlation. FIG. 9 shows the type I error in the null hypothesis in the case of the present algorithm and the type I error in the null hypothesis in the case of the separate3 method obtained by simulation.

As shown in FIG. 9, the type I error in the case of the present algorithm coincides with the level of significance 0.05, while the type I error is underestimated in the case of the separate3 method. From this result, it can be said that the analysis based on the present algorithm has the advantage over the method of estimating existing diplotype configurations and performing a test by using a contingency table.

<Analysis of Real Data 1>

We applied the present algorithm to real data actually collected. As the real data, data on MTHFR gene [Urano et al. (2002) Polymorphisms in the methylenetetrahydrofolate reductase gene were associated with both the efficacy and the toxicity of methotrexate used for the treatment of rheumatoid arthritis, as evidenced by single locus and haplotype analyses. Pharmacogenetics. 12:183-190] and the NAT2 gene [Tanaka et al. (2002) Adverse effects of sulfasalazine in patients with rheumatoid arthritis are associated with diplotype configuration at the N-acetyltransferase 2 gene. J Rheumatol 29:2492-2499]. Both the data on MTHFR gene and the data on NAT2 gene are derived from cohort studies.

The data set for MTHFR is derived from the cohort study on rheumatoid arthritis patients. An examination was made as to the occurrence of side effects and the state of two SNPs of MTFHR gene with respect to 104 patients who received methotrexate. One haplotype was assumed to be “phenotype-associated haplotype”.

The statistic −2log(L₀ₘₐₓ/Lₘₐₓ) calculated from the data was 6.8074, which is significant (P<0.01). The maximum likelihood estimates of “q₊ hat” and “q₋ hat” in this case were 0.2571 and 0.0588, respectively. That is, the maximum likelihood estimate of the relative risk was 4.37. The diplotype distributions of the individuals were concentrated on a single event. The diplotype configurations estimated under the alternative hypothesis with respect to all the individuals were approximately the same as those estimated under the null hypothesis or those estimated by LDSUPPORT (while the data is not shown). That is, in this example, the estimated diplotype configurations were approximately the same regardless of which of the present algorithm using phenotype data or LDSUPPORT not using phenotype data was used. “Θ hat” was also the same regardless of which of the present algorithm or LDSUPPORT was used.

The data set for NAT2 gene is also derived from the cohort study on rheumatoid arthritis patients. This data set was obtained by making a search with respect to the occurrence of side effects and seven SNPs in NET2 gene in 144 patients who received sulfasalazine (see the above-mentioned document by Tanaka et al.) One haplotype recognized in advance as a wild-type haplotype was assumed to be “phenotype-associated haplotype”. The statistic −2log(L₀ₘₐₓ/Lₘₐₓ) calculated from the data was 13.4629, which is significant (P<0.001) showing that the presence of the haplotype is associated with the side effects. The maximum likelihood estimates of “q₊ hat” and “q₋ hat” were 0.0809 and 0.6248, respectively. That is, the maximum likelihood estimate of the relative risk was 0.129. That is, the presence of the “phenotype-associated haplotype” was associated with a reduction in the side effects.

The diplotype distributions of the individuals were concentrated on a single event except for that for one individual. The diplotype configurations estimated under the alternative hypothesis with respect to all the individuals were the same as those estimated under the null hypothesis or those estimated by LDSUPPORT.

According to the results of analysis using real data, the penetrance can be calculated by the present algorithm using genotype data and phenotype data. Then, the association between a phenotype and a haplotype at the level of individuals can be tested by the present algorithm using the genotype data and phenotype data. Also, maximum likelihood estimation of the penetrance can be performed by the present algorithm on the assumption that different penetrances are obtained according to the existence/nonexistence of a particular haplotype. Further, a maximum likelihood estimate of the relative risk can, of course, be obtained from the different penetrances.

We also analyzed the genotype data comprising the seven SNPs for NAT2 gene and data on the side effects, which data were obtained from a cohort study on the 144 rheumatoid arthritis patients who received sulfasalazine, with the above-described incomplete haplotypes H₁ provided as an object to be tested. From this data, it has been shown that the risk of generation of the side effects in the case where the wild-type haplotype is possessed is descreased or 0.129/1 of the risk in the case where the wild-type haplotype is not possessed, as described above.

More specifically, the wild-type haplotype is expressed by an SNP sequence “GCTCGAG” and, when incomplete haplotypes were constructed by the above-described method, an analysis result showing that “GC****G” was most significant was obtained without designating the wild-type haplotype. The symbol “*” indicates the masked state. That is, in this example, the third to sixth loci can be masked and incomplete haplotypes H₁ constructed on SNPs at the first, second and seventh loci can be provided as an object to be tested. As a result of application of the present algorithm using the constructed incomplete haplotypes H₁ as an object to be tested, it was found that “GC****G” was most significant. It is meant that the masked loci as shown in “GC****G” are expressed by information on the other loci, and that the fact that “C” is at the second locus and “G” is at the seventh locus is associated with the phenotype. The wild-type haplotype “GCTCGAG” is a haplotype correctly conforming to “GC****G”. Thus, the “phenotype-associated haplotype” can be found by using incomplete haplotypes H₁.

Further, another example of application using incomplete haplotypes H₁ is analysis performed on genotype data comprising three SNPs for ABCB8 gene and data on execution/non-execution of dosing with folic acid to be performed in the event of occurrence of a side effect, which data were obtained from a cohort study on 175 rheumatoid arthritis patients who received methotrexate, with incomplete haplotypes used as an object to be tested. Table 9 shows the results of this analysis.

TABLE 9

| Particle haplotype | P value | q₋ | q₊ | Relative risk |
|---|---|---|---|---|
| CG* | 8.65E−05 | 0.1935 | 0.4867 | 2.515 |
| CGA | 1.17E−03 | 0.2737 | 0.5125 | 1.872 |
| *G* | 2.69E−03 | 0.1250 | 0.4238 | 3.390 |
| CAG | 1.09E−02 | 0.4872 | 0.2990 | 0.614 |
| C*G | 2.09E−02 | 0.5091 | 0.3250 | 0.638 |
| **G | 2.59E−01 | 0.5455 | 0.3720 | 0.682 |
| CGG | 4.00E−01 | 0.3657 | 0.4390 | 1.200 |
| *GG | 4.91E−01 | 0.3492 | 0.4018 | 1.151 |
| TGG | 8.87E−01 | 0.3778 | 0.3882 | 1.028 |
| C** | 8.92E−01 | 0.3636 | 0.3841 | 1.056 |

In the analysis results shown in Table 9, the haplotype “CG*” has the lowest P value indicating that the haplotype “CG*” is more significant than thee haplotype “CGA” using information on all the loci. This means that the incomplete haplotype “CG” on the first and second loci is strongly associated with the cause of the phenotype. That is, it can be understood that the cause locus is associated with both the haplotypes “CGA” and “CGG”, and that the association with the phenotype appears strongly when the third locus is masked. These results show that even a phenotype associated with a plurality of haplotypes can be detected when incomplete haplotypes H₁ are used.

### INDUSTRIAL APPLICABILITY

According to the present invention, it is possible to perform maximum likelihood estimation of haplotype frequencies in a population, diplotype distributions of individuals (posterior probability distributions of diplotype configurations) and penetrances by using genotype data and phenotype data, with no need to definitely determine diplotype configurations of the individuals. If the algorithm in accordance with the present invention is used, the association between the existence of a haplotype and one phenotype can be tested by using genotype data and phenotype data obtained as a result of, for example, a cohort study, a clinical trial or a case-control study.

1. A penetrance estimation method comprising:
a step a of calculating, on the basis of genotype data and phenotype data with haplotype frequencies and penetrance used as parameters, the maximum likelihood (L₀ₘₐₓ) obtained by maximizing likelihood under the hypothesis that there is no association between predetermined diplotype configurations and a predetermined phenotype, the maximum likelihood estimates of haplotype frequencies and penetrances, and the maximum likelihood (Lₘₐₓ) obtained by maximizing likelihood under the hypothesis that there is an association between the predetermined diplotype configurations and the predetermined phenotype; and
a step b of obtaining the penetrance from the maximum likelihood estimates obtained in the step a.

2. The penetrance estimation method according to claim 1, wherein genotype data and phenotype data obtained as a result of a cohort study or a clinical trial and observed in a predetermined population are used,
wherein, in said step a, the maximum likelihood (Lₘₐₓ) is obtained by maximizing the following expression (I) over Θ, q₊ and q₋:
$$L ( Θ , {q}_{+} , {q}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{+} , {q}_{-} ) \qquad ( I )$$
and the maximum likelihood (L₀ₘₐₓ) is obtained by maximizing the following expression (II) over Θ and q₀:
$$L ( Θ , {q}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{0} ) \qquad ( II )$$
(in expressions (I) and (II), Θ denotes a vector of the haplotype frequencies; q₊ denotes the probability that a phenotype ψ₊ results under
diεD₊
where D₊ denotes a set of diplotype configurations containing elements of a set of haplotypes relating to the predetermined phenotype, and dᵢ denotes a diplotype configuration of the ith individual in N individuals; q₋ denotes the probability that a phenotype ψ₊ results under
di∉D₊
; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual), and
wherein the penetrance is obtained as q₊.

3. The penetrance estimation method according to claim 1, wherein genotype data and phenotype data obtained as a result of a case-control study are used,
wherein, in said step a, the maximum likelihood (Lₘₐₓ) is obtained by maximizing the following expression (I) over Θ, r₊ and r₋:
$$L ( Θ , {r}_{+} , {r}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{+} , {r}_{-} ) \qquad ( I )$$
and the maximum likelihood (L₀ₘₐₓ) is obtained by maximizing the following expression (II) over Θ and r₀:
$$L ( Θ , {r}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{0} ) \qquad ( II )$$
(in expressions (I) and (II), Θ denotes a vector of the haplotype frequencies; r₊ denotes an estimate under
diεD₊
where D₊ denotes a set of diplotype configurations containing elements of a set of haplotypes relating to the predetermined phenotype, and dᵢ denotes a diplotype configuration of the ith individual in N individuals; r₋ denotes an estimate under
di∉D₊
; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual), and
wherein the penetrance is obtained as q₊ by substituting r₊ obtained by expression (I) in the following equation:
$${q}_{+} = \frac{1}{\frac{ω}{( 1 - ω )} \frac{( 1 - {r}_{+} )}{{r}_{+}} \frac{( 1 - λ )}{λ} + 1}$$
where λ denotes the proportion of cases in the entire population, and ω denotes the proportion of a case population in a population formed of the case population and a control population extracted from the entire population.

4. The penetrance estimation method according to claim 1, wherein a set of haplotypes to be tested is defined in such a limiting manner that loci for giving information for discrimination between individual haplotypes and loci having redundant information due to combinations of the loci having the discrimination information are determined on the basis of the haplotype frequencies used as a parameter, and the determined loci are masked.

5. A penetrance estimation program enabling a computer to execute:
a step a of calculating, by means of control means, on the basis of genotype data and phenotype data obtained through input means, with haplotype frequencies and penetrance used as parameters, the maximum likelihood (L₀ₘₐₓ) obtained by maximizing likelihood under the hypothesis that there is no association between predetermined diplotype configurations and a predetermined phenotype, the maximum likelihood estimates of haplotype frequencies and penetrances, and the maximum likelihood (Lₘₐₓ) obtained by maximizing likelihood under the hypothesis that there is an association between the predetermined diplotype configurations and the predetermined phenotype; and
a step b of obtaining, by means of the control means, the penetrances from the maximum likelihood estimates obtained in said step a.

6. The penetrance estimation program according to claim 5, wherein genotype data and phenotype data obtained as a result of a cohort study or a clinical trial and observed in a predetermined population are used,
wherein, in said step a, the maximum likelihood (Lₘₐₓ) is obtained by maximizing the following expression (I) over Θ, q₊ and q₋:
$$L ( Θ , {q}_{+} , {q}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{+} , {q}_{-} ) \qquad ( I )$$
and the maximum likelihood (L₀ₘₐₓ) is obtained by maximizing the following expression (II) over Θ and q₀:
$$L ( Θ , {q}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{0} ) \qquad ( II )$$
(in expressions (I) and (II), Θ denotes a vector of the haplotype frequencies; q₊ denotes the probability that a phenotype ψ₊ results under
diεD₊
where D₊ denotes a set of diplotype configurations containing elements of a set of haplotypes relating to the predetermined phenotype, and dᵢ denotes a diplotype configuration of the ith individual in N individuals; q₋ denotes the probability that a phenotype ψ₊ results under
di∉D₊
; ψᵢ is denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual), and
wherein the penetrance is obtained as q₊.

7. The penetrance estimation program according to claim 5, wherein genotype data and phenotype data obtained as a result of a case-control study are used,
wherein, in said step a, the maximum likelihood (Lₘₐₓ) is obtained by maximizing the following expression (I) over Θ, r₊ and r₋:
$$L ( Θ , {r}_{+} , {r}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{+} , {r}_{-} ) \qquad ( I )$$
and the maximum likelihood (L₀ₘₐₓ) is obtained by maximizing the following expression (II) over Θ and r₀:
$$L ( Θ , {r}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{0} ) \qquad ( II )$$
(in expressions (I) and (II), Θ denotes a vector of the haplotype frequencies; r₊ denotes an estimate under
diεD₊
where D₊denotes a set of diplotype configurations containing elements of a set of haplotypes relating to the predetermined phenotype, and dᵢ denotes a diplotype configuration of the ith individual in N individuals; r₋ denotes an estimate under
di∉D₊
; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual), and
wherein the penetrance is obtained as q₊ by substituting r₊ obtained by expression (I) in the following equation:
$${q}_{+} = \frac{1}{\frac{ω}{( 1 - ω )} \frac{( 1 - {r}_{+} )}{{r}_{+}} \frac{( 1 - λ )}{λ} + 1}$$
where λ denotes the proportion of cases in the entire population, and ω denotes the proportion of a case population in a population consisting of the case population and a control population extracted from the entire population.

8. The penetrance estimation program according to claim 5, wherein a set of haplotypes to be tested is defined in such a limiting manner that loci for giving information for discrimination between individual haplotypes and loci having redundant information due to combinations of the loci having the discrimination information are determined on the basis of the haplotype frequencies used as a parameter, and the determined loci are masked.

9. A method of testing a relationship between a diplotype and a phenotype, comprising:
a step a of calculating, on the basis of genotype data and phenotype data with haplotype frequencies and penetrance used as parameters, the maximum likelihood (L₀ₘₐₓ) obtained by maximizing likelihood under the hypothesis that there is no association between predetermined diplotype configurations and a predetermined phenotype, the maximum likelihood estimates of haplotype frequencies and penetrances, and the maximum likelihood (Lₘₐₓ) obtained by maximizing likelihood under the hypothesis that there is an association between the predetermined diplotype configurations and the predetermined phenotype; and
a step b of obtaining the likelihood ratio from the maximum likelihood (L₀ₘₐₓ) and the maximum likelihood (Lₘₐₓ) obtained in said step a, and testing, with reference to an λ² distribution, the hypothesis that there is an association between the predetermined deplotype configurations and the predetermined phenotype.

10. The method of testing a relationship between a diplotype and a phenotype, according to claim 9, wherein genotype data and phenotype data obtained as a result of a cohort study or a clinical trial and observed in a predetermined population are used,
wherein, in said step a, the maximum likelihood (Lₘₐₓ) is obtained by maximizing the following expression (I) over Θ, q₊ and q₋:
$$L ( Θ , {q}_{+} , {q}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{+} , {q}_{-} ) \qquad ( I )$$
and the maximum likelihood (L₀ₘₐₓ) is obtained by maximizing the following expression (II) over Θ and q₀:
$$L ( Θ , {q}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{0} ) \qquad ( II )$$
(in expressions (I) and (II), Θ denotes a vector of the haplotype frequencies; q₊ denotes the probability that a phenotype ψ₊ results under
diεD₊
where D₊ denotes a set of diplotype configurations containing elements of a set of haplotypes relating to the predetermined phenotype, and dᵢ denotes a diplotype configuration of the ith individual in N individuals; q₋ denotes the probability that a phenotype ψ₊ results under
di∉D₊
; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual), and
wherein the penetrance is obtained as q₊.

11. The method of testing a relationship between a diplotype and a phenotype, according to claim 9, wherein genotype data and phenotype data obtained as a result of a case-control study are used,
wherein, in said step a, the maximum likelihood (Lₘₐₓ) is obtained by maximizing the following expression (I) over Θ, r₊ and r₋:
$$L ( Θ , {r}_{+} , {r}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{+} , {r}_{-} ) \qquad ( I )$$
and the maximum likelihood (L₀ₘₐₓ) is obtained by maximizing the following expression (II) over Θ and r₀:
$$L ( Θ , {r}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{0} ) \qquad ( II )$$
(in expressions (I) and (II), Θ denotes a vector of the haplotype frequencies; r₊ denotes an estimate under
diεD₊
where D₊ denotes a set of diplotype configurations containing elements of a set of haplotypes relating to the predetermined phenotype, and dᵢ denotes a diplotype configuration of the ith individual in N individuals; r₋ denotes an estimate under
di∉D₊
; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual), and
wherein the penetrance is obtained as q₊ by substituting r₊ obtained by expression (I) in the following equation:
$${q}_{+} = \frac{1}{\frac{ω}{( 1 - ω )} \frac{( 1 - {r}_{+} )}{{r}_{+}} \frac{( 1 - λ )}{λ} + 1}$$
where λ denotes the proportion of cases in the entire population, and ω denotes the proportion of a case population in a population formed of the case population and a control population extracted from the entire population.

12. The method of estimating the probability of development of a phenotype, according to claim 9, wherein a set of haplotypes to be tested is defined in such a limiting manner that loci for giving information for discrimination between individual haplotypes and loci having redundant information due to combinations of the loci having the discrimination information are determined on the basis of the haplotype frequencies used as a parameter, and the determined loci are masked.

13. The method of estimating the probability of development of a phenotype, according to claim 9, wherein, in said step b, −2log(Lₘₐₓ/L₀ₘₐₓ) is obtained as a statistic (where log denotes natural logarithm), and wherein because the static asymptotically follows the λ² distribution with the degree of freedom of 1 in a case where the diplotype configuration and the phenotype are independent of each other, it is determined that it cannot be said that there is an association between the predetermined diplotype and the predetermined phenotype, when the statistic does not exceed a limit value λ²< (which is a value at which a cumulative distribution function is 1−α in λ² distribution with the degree of freedom of 1, where α denotes the risk rate of the test), and it is determined that there is an association between the predetermined diplotype and the predetermined phenotype, when the statistic exceeds the limit value λ²<.

14. A program for testing a relationship between a diplotype configuration and a phenotype, said program enabling a computer to execute:
a step a of calculating, by means of control means, on the basis of genotype data and phenotype data input through input means, with haplotype frequencies and penetrance used as parameters, the maximum likelihood (L₀ₘₐₓ) obtained by maximizing likelihood under the hypothesis that there is no association between predetermined diplotype configurations and a predetermined phenotype, the maximum likelihood estimates of haplotype frequencies and penetrances, and the maximum likelihood (Lₘₐₓ) obtained by maximizing likelihood under the hypothesis that there is an association between the predetermined diplotype configurations and the predetermined phenotype; and
a step b of obtaining, by means of the control means, the likelihood ratio from the maximum likelihood (L₀ₘₐₓ) and the maximum likelihood (Lₘₐₓ) obtained in said step a, and testing, by means of the control means, with reference to an λ² distribution, the hypothesis that there is an association between the predetermined deplotype configurations and the predetermined phenotype.

15. The program for testing a relationship between a diplotype configuration and a phenotype, according to claim 14, wherein genotype data and phenotype data obtained as a result of a cohort study or a clinical trial and observed in a predetermined population are used, wherein, in said step a, the maximum likelihood (Lₘₐₓ) is obtained by maximizing the following expression (I) over Θ, q₊ and q₋:
$$L ( Θ , {q}_{+} , {q}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{+} , {q}_{-} ) \qquad ( I )$$
and the maximum likelihood (L₀ₘₐₓ) is obtained by maximizing the following expression (II) over Θ and q₀:
$$L ( Θ , {q}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{0} ) \qquad ( II )$$
(in expressions (I) and (II), Θ denotes a vector of the haplotype frequencies; q₊ denotes the probability that a phenotype ψ₊ results under
diεD₊
where D₊ denotes a set of diplotype configurations containing elements of a set of haplotypes relating to the predetermined phenotype, and dᵢ denotes a diplotype configuration of the ith individual in N individuals; q₋ denotes the probability that a phenotype ψ₊ results under
di∉D₊
; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual), and
wherein the penetrance is obtained as q₊.

16. The program for testing a relationship between a diplotype configuration and a phenotype, according to claim 14, wherein genotype data and phenotype data obtained as a result of a case-control study are used,
wherein, in said step a, the maximum likelihood (Lₘₐₓ) is obtained by maximizing the following expression (I) over Θ, r₊ and r₋:
$$L ( Θ , {r}_{+} , {r}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{+} , {r}_{-} ) \qquad ( I )$$
the maximum likelihood (L₀ₘₐₓ) is obtained by maximizing the following expression (II) over Θ and r₀:
$$L ( Θ , {r}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{0} ) \qquad ( II )$$
(in expressions (I) and (II), Θ denotes a vector of the haplotype frequencies; r₊ denotes an estimate under
diεD₊
where D₊ denotes a set of diplotype configurations containing elements of a set of haplotypes relating to the predetermined phenotype, and dᵢ denotes a diplotype configuration of the ith individual in N individuals; r₋ denotes an estimate under
di∉D₊
; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual), and
wherein the penetrance is obtained as q₊ by substituting r₊ obtained by expression (I) in the following equation:
$${q}_{+} = \frac{1}{\frac{ω}{( 1 - ω )} \frac{( 1 - {r}_{+} )}{{r}_{+}} \frac{( 1 - λ )}{λ} + 1}$$
where λ denotes the proportion of cases in the entire population, and ω denotes the proportion of a case population in a population consisting of the case population and a control population extracted from the entire population.

17. The program for testing a relationship between a diplotype configuration and a phenotype, according to claim 14, wherein a set of haplotypes to be tested is defined in such a limiting manner that loci for giving information for discrimination between individual haplotypes and loci having redundant information due to combinations of the loci having the discrimination information are determined on the basis of the haplotype frequencies used as a parameter, and the determined loci are masked.

18. The program for testing a relationship between a diplotype configuration and a phenotype, according to claim 14, wherein, in said step b, −2log(Lₘₐₓ/L₀ₘₐₓ) is obtained as a statistic (where log denotes natural logarithm), and wherein because the static asymptotically follows the λ² distribution with the degree of freedom of 1 in a case where the diplotype configuration and the phenotype are independent of each other, it is determined that it cannot be said that there is an association between the predetermined diplotype and the predetermined phenotype, when the statistic does not exceed a limit value λ²< (which is a value at which a cumulative distribution function is 1−α in the λ² distribution with the degree of freedom of 1, where α denotes the risk rate of the test), and it is determined that there is an association between the predetermined diplotype and the predetermined phenotype, when the statistic exceeds the limit value λ²<.

19. A method of estimating the probability of development of a phenotype, comprising:
a step a of calculating, on the basis of genotype data and phenotype data with haplotype frequencies and penetrance used as parameters, the maximum likelihood (L₀ₘₐₓ) obtained by maximizing likelihood under the hypothesis that there is no association between predetermined diplotype configurations and a predetermined phenotype, the maximum likelihood estimates of haplotype frequencies and penetrance, the maximum likelihood (Lₘₐₓ) obtained by maximizing likelihood under the hypothesis that there is an association between the predetermined diplotype configurations and the predetermined phenotype; and
a step b of obtaining the probability that tested individual develops the predetermined phenotype configurations, by using the maximum likelihood estimates obtained in said step a and the genotype data on the tested individual.

20. The method of estimating the probability of development of a phenotype, according to claim 19, wherein genotype data and phenotype data obtained as a result of a cohort study or a clinical trial and observed in a predetermined population are used,
wherein, in said step a, the maximum likelihood (Lₘₐₓ) is obtained by maximizing the following expression (I) over Θ, q₊ and q₋:
$$L ( Θ , {q}_{+} , {q}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{+} , {q}_{-} ) \qquad ( I )$$
and the maximum likelihood (L₀ₘₐₓ) is obtained by maximizing the following expression (II) over Θ and q₀:
$$L ( Θ , {q}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{0} ) \qquad ( II )$$
(in expressions (I) and (II), Θ denotes a vector of the haplotype frequencies; q₊ denotes the probability that a phenotype ψ₊ results under
diεD₊
where D₊ denotes a set of diplotype configurations containing elements of a set of haplotypes relating to the predetermined phenotype, and dᵢ denotes a diplotype configuration of the ith individual in N individuals; q₋ denotes the probability that a phenotype ψ₊ results under
di∉D₊
; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual), and
wherein the penetrance is obtained as q₊.

21. The method of estimating the probability of development of a phenotype, according to claim 19, wherein genotype data and phenotype data obtained as a result of a case-control study are used,
wherein, in said step a, the maximum likelihood (Lₘₐₓ) is obtained by maximizing the following expression (I) over Θ, r₊ and r₋:
$$L ( Θ , {r}_{+} , {r}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{+} , {r}_{-} ) \qquad ( I )$$
and the maximum likelihood (L₀ₘₐₓ) is obtained by maximizing the following expression (II) over Θ and r₀:
$$L ( Θ , {r}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{0} ) \qquad ( II )$$
(in expressions (I) and (II), Θ denotes a vector of the haplotype frequencies; r₊ denotes an estimate under
diεD₊
where D₊denotes a set of diplotype configurations containing elements of a set of haplotypes relating to the predetermined phenotype, and dᵢ denotes a diplotype configuration of the ith individual in N individuals; r₋ denotes an estimate under
di∉D₊
; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual), and
wherein the penetrance is obtained as q₊ by substituting r₊ obtained by expression (I) in the following equation:
$${q}_{+} = \frac{1}{\frac{ω}{( 1 - ω )} \frac{( 1 - {r}_{+} )}{{r}_{+}} \frac{( 1 - λ )}{λ} + 1}$$
where λ denotes the proportion of cases in the entire population, and ω denotes the proportion of a case population in a population consisting of the case population and a control population extracted from the entire population.

22. The method of estimating the probability of development of a phenotype, according to claim 19, wherein a set of haplotypes to be tested is defined in such a limiting manner that loci for giving information for discrimination between individual haplotypes and loci having redundant information due to combinations of the loci having the discrimination information are determined on the basis of the haplotype frequencies used as a parameter, and the determined loci are masked.

23. The method of estimating the probability of development of a phenotype, according to claim 19, wherein, in said step b, the probability is obtained by the following equation (III):
$$P ( {ψ}_{N + 1} = {ψ}_{+} \vert {g}_{N + 1} , \hat{Θ} ) = {\hat{q}}_{+} {\sum }_{{a}_{k} ∈ {D}_{+}} P ( {d}_{N + 1} = {a}_{k} \vert {g}_{N + 1} , \hat{Θ} ) + {\hat{q}}_{-} {\sum }_{{a}_{k} ∈ {D}_{+}} P ( {d}_{N + 1} = {a}_{k} \vert {g}_{N + 1} , \hat{Θ} ) \qquad ( III )$$
(In equation (III), the tested individual is shown as the N+1th individual, g_{N+1} denotes a genotype of the observed individual, and
\hat{Θ}
\hat{q}_{+\hat{q}}₋
respectively denote the values of Θ, q₊ and q₋ at which L(Θ, q₊ and q₋) is maximized in said step a).

24. A program for estimating the probability of development of a phenotype, said program enabling a computer to execute:
a step a of calculating, on the basis of genotype data and phenotype data obtained through input means, with haplotype frequencies and penetrance used as parameters, the maximum likelihood (L₀ₘₐₓ) obtained by maximizing likelihood under the hypothesis that there is no association between predetermined diplotype configurations and a predetermined phenotype, the maximum likelihood estimates of haplotype frequencies and penetrances, the maximum likelihood (Lₘₐₓ) obtained by maximizing the likelihood under a hypothesis that there is an association between the predetermined diplotype configurations and the predetermined phenotype; and
a step b of obtaining, by means of control means, the probability that tested individual develops the predetermined phenotype configurations, by using the maximum likelihood estimates obtained in said step a and the genotype data on the tested individual.

25. The program of estimating the probability of development of a phenotype, according to claim 24, wherein genotype data and phenotype data obtained as a result of a cohort study or a clinical trial and observed in a predetermined population are used,
wherein, in said step a, the maximum likelihood (Lₘₐₓ) is obtained by maximizing the following expression (I) over Θ, q₊ and q₋:
$$L ( Θ , {q}_{+} , {q}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{+} , {q}_{-} ) \qquad ( I )$$
and the maximum likelihood (L₀ₘₐₓ) is obtained by maximizing the following expression (II) over Θ and q₀:
$$L ( Θ , {q}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {q}_{0} ) \qquad ( II )$$
(in expressions (I) and (II), Θ denotes a vector of the haplotype frequencies; q₊ denotes the probability that a phenotype ψ₊ results under
diεD₊
where D₊ denotes a set of diplotype configurations containing elements of a set of haplotypes relating to the predetermined phenotype, and dᵢ denotes a diplotype configuration of the ith individual in N individuals; q₋ denotes the probability that a phenotype ψ₊ results under
dᵢ∉D₊
; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual), and
wherein the penetrance is obtained as q₊.

26. The program of estimating the probability of development of a phenotype, according to claim 24, wherein genotype data and phenotype data obtained as a result of a case-control study are used,
wherein, in said step a, the maximum likelihood (Lₘₐₓ) is obtained by maximizing the following expression (I) over Θ, r₊ and r₋:
$$L ( Θ , {r}_{+} , {r}_{-} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{+} , {r}_{-} ) \qquad ( I )$$
and the maximum likelihood (L₀ₘₐₓ) is obtained by maximizing the following expression (II) over Θ and r₀:
$$L ( Θ , {r}_{0} ) ∝ {\prod }_{i = 1}^{N} {\sum }_{{a}_{k} ∈ {A}_{i}} P ( {d}_{i} = {a}_{k} \vert Θ ) P ( {ψ}_{i} = {w}_{i} \vert {d}_{i} = {a}_{k} , {r}_{0} ) \qquad ( II )$$
(in expressions (I) and (II), Θ denotes a vector of the haplotype frequencies; r₊ denotes an estimate under
diεD₊
where D₊ denotes a set of diplotype configurations containing elements of a set of haplotypes relating to the predetermined phenotype, and dᵢ denotes a diplotype configuration of the ith individual in N individuals; r₋ denotes an estimate under
di∉D+
; ψᵢ denotes a phenotype as a random variable of the ith individual; wᵢ denotes a phenotype as a measured value of the ith individual; aₖ denotes a possible diplotype configuration of the kth individual; and Ai denotes a set of diplotype configurations consistent with genotype data gᵢ on the ith individual), and
wherein the penetrance is obtained as q₊ by substituting r₊ obtained by expression (I) in the following equation:
$${q}_{+} = \frac{1}{\frac{ω}{( 1 - ω )} \frac{( 1 - {r}_{+} )}{{r}_{+}} \frac{( 1 - λ )}{λ} + 1}$$
where λ denotes the proportion of cases in the entire population, and ω denotes the proportion of a case population in a population consisting of the case population and a control population extracted from the entire population.

27. The program of estimating the probability of development of a phenotype, according to claim 24, wherein a set of haplotypes to be tested is defined in such a limiting manner that loci for giving information for discrimination between individual haplotypes and loci having redundant information due to combinations of the loci having the discrimination information are determined on the basis of the haplotype frequencies used as a parameter, and the determined loci are masked.

28. The program of estimating the probability of development of a phenotype, according to claim 20, wherein, in said step b, the probability is obtained by the following equation (III):
$$\begin{matrix}P ( {ψ}_{N + 1} = {ψ}_{+} \vert {g}_{N + 1} , \hat{Θ} ) = {\hat{q}}_{+} {\sum }_{{a}_{k} ∈ {D}_{+}} P ( {d}_{N + 1} = {a}_{k} \vert {g}_{N + 1} , \hat{Θ} ) + \\ {\hat{q}}_{-} {\sum }_{{a}_{k} ∈ {D}_{+}} P ( {d}_{N + 1} = {a}_{k} \vert {g}_{N + 1} , \hat{Θ} )\end{matrix} \qquad ( III )$$
(In equation (III), the tested individual is indicated as the N+1th individual, g_{N+1} denotes a genotype of the observed individual, and
\hat{Θ}
\hat{q}₊
\hat{q}₋
respectively denote the values of Θ, q₊ and q₋ at which L(Θ, q₊ and q₋) is maximized in said step a).
